(19) United States
(12) Patent Application Publication
(10) Pub. No.: US 2026/0310498 A1
(43) Pub. Date: Oct. 8, 2026

(54) TASK ORCHESTRATOR AND METHOD FOR TASK ORCHESTRATION AND EXECUTION

(71) Applicant: Azaios, Inc., Anacortes, WA (US)

(72) Inventors: Marc PIERNE, Anacortes, WA (US); Jon LAWRENCE, Anacortes, WA (US)

(21) Appl. No.: 19/571,377

(22) Filed: Mar. 18, 2026

Related U.S. Application Data
(60) Provisional application No. 63/785,297, filed on Apr. 8, 2025.

(51) Int. Cl. G06F 9/48; G06F 9/50

(52) U.S. Cl. CPC G06F 9/4881; G06F 9/5027

(57) ABSTRACT

A method for executing a compute task using heterogeneous hardware resources of a compute environment includes receiving a compute task, constructing, by a trained decision tree machine learning model, a base task plan that associates the compute task with hardware resources of the compute environment, generating, by a neuromorphic model, one or more task plan variants and a routing score for each task plan variant based on continuously learned routing performance encoded through spike-timing-dependent plasticity (STDP), evaluating the base task plan together with the one or more task plan variant by executing a tree search based on one or more of predicted latency, predicted cost, predicted error risk, and predicted policy compliance of executing the compute task, selecting a task plan based on a result of the evaluation and the one or more routing scores, and dispatching steps of the compute task to hardware resources according to the task plan.

### CROSS-REFERENCE APPLICATIONS

This application claims priority to U.S. Provisional No. 63/785,297 filed on Apr. 8, 2025, and is incorporated herein in its entirety.

### BACKGROUND

As artificial intelligence (AI) models continue to scale, enterprises face challenges related to the efficient management of multi-modal data, ensuring compliance with data governance policies, and optimizing hardware resources used in the training, inference and operation of AI models. Existing systems often lack adaptability, scalability, and robust lineage tracking, leading to inefficiencies in data integrity, regulatory compliance, and hardware utilization.

Large scale data processing operations, such as machine learning (ML) operations performed for AI models, are typically handled by data centers. A data center receives data to be processed through an input/output (I/O) layer. When the amount of data is large, the data is distributed across multiple hardware resources after passing through the I/O layer and processed to reassemble the data. Some form of load balancing may be applied at this phase to spread the reassembly load across the hardware resources and ensure maximum resource utilization.

After the data is reassembled, it is fed into a processing pipeline along with other data and distributed across a different set of processing resources. The distribution of multiple processing operations in the pipeline can be managed by an algorithm that attempts to balance the processing load across the resources by ensuring that each processor is used to the greatest extent possible, e.g., as close to the capacity limit as possible, without becoming a bottleneck.

Modern AI systems routinely execute heterogeneous workloads such as inference, training, retrieval, extract, transform, and load (ETL), and multimodal processing, across distributed infrastructure that may include CPUs, GPUs, TPUs, FPGAs, NPUs, and edge devices. A persistent engineering problem is that static schedulers and fixed routing tables typically cannot adapt quickly enough to changing conditions such as bursty arrivals, device contention, variable network performance, fluctuating cost constraints, and strict Service Level Objectives (SLOs). As a result, conventional systems often exhibit one or more of: (i) latency spikes and tail amplification; (ii) over-provisioning to meet SLOs; (iii) poor device utilization; (iv) degraded reliability when preferred paths fail; and (v) inability to enforce task feasibility constraints early and consistently.

Additionally, some classes of computational workloads benefit from different execution strategies, e.g., exact vs. approximate approaches, and selecting the most efficient strategy can require either expensive search or brittle heuristics. These limitations become more acute when the system must process large volumes of tasks, maintain determinism of operational policy, and continuously improve routing performance based on observed outcomes.

### SUMMARY

Embodiments of the present disclosure may address challenges associated with executing heterogenous compute tasks through a neuromorphic (brain-like) service architecture coupled with a multi-agent system for intelligent data routing, governance, compression, and resource optimization. For example, embodiments of the present disclosure provide a system and methods that may address the shortcomings of conventional approaches to distributed tasks by using a closed-loop control plane performing one or more of: (a) validate and normalize incoming workloads into a consistent task structure; (b) predict feasibility under SLO, cost, and resource constraints; (c) adaptively route tasks based on observed performance; (d) choose between specialized execution strategies in constant time; (e) allocate heterogeneous devices as a unified resource plane; (f) apply operational policy constraints; and (g) consolidate distributed results efficiently.

Embodiments relate to systems and methods for decision-engine driven infrastructure and dynamic resource orchestration that receives heterogeneous work requests (including, e.g., agent calls, interactive user interface/integrated development environment (UI/IDE) requests, streaming events, bulk objects, and training artifacts), transforms each request into a validated task envelope, and orchestrates execution across a plurality of heterogeneous compute resources and a multi-lane execution layer.

In one embodiment, a main load optimizer (e.g., a global task orchestrator) evaluates each task envelope using multiple cooperating decision modules, including one or more of: (i) a quantum-inspired embedder that computes task-resource similarity in an embedding space derived from extracted task features; (ii) a search-tree based planner, e.g., a Monte Carlo Tree Search (MCTS) planner that decomposes tasks and predicts resource feasibility using a multi-armed bandit algorithm such as UCB1; (iii) a neuromorphic task router that creates sub-millisecond adaptive routing plan variants using software-simulated spiking neuron dynamics (e.g., leaky integrate-and-fire (LIF)) with online learning (e.g., spike-timing-dependent plasticity (STDP)); (iv) a simulated annealing optimizer that refines candidate task plans using an energy objective combining latency, cost, and SLO violations; and (v) a lane router that selects an execution lane in constant time based on task or circuit characteristics. The planner then generates a task plan and the orchestrator then uses that task plan to bind execution to particular nodes and device resources, then ensures that the task dispatcher routes the task to an appropriate queue, then the orchestrator ensures the task plan, dispatch plan and task performance telemetry are recorded as a versioned, auditable artifact.

The execution layer includes (a) a heterogeneous device manager that discovers and abstracts compute devices across environments and assigns tasks to physical or virtual resources according to the binding instructions included in the dispatch plan to physical or virtual resources, (b) a set of execution lanes providing specialized compute paths (e.g., state-vector simulation, tensor network simulation, stabilizer/QEC simulation, variational (VQE) loops, and variance-reduction execution), and (c) a results combiner that consolidates distributed outputs into a unified deliverable with reduced network round-trips and rule-based conflict resolution.

The disclosed architecture may operate with a plurality of custom-trained transformer models that underpin prediction, metrics interpretation, and self-improvement.

Embodiments of the present application relate to a method for executing a compute task using heterogeneous hardware resources of a compute environment. The method may include receiving, via an ingress interface, a compute task, constructing, by a trained decision tree machine learning model, a base task plan that associates the compute task with hardware resources of the compute environment, generating, by a neuromorphic model, one or more task plan variants and a routing score for each task plan variant based on continuously learned routing performance encoded through spike-timing-dependent plasticity (STDP), evaluating the base task plan together with the one or more task plan variant by executing a tree search based on one or more of predicted latency, predicted cost, predicted error risk, and predicted policy compliance of executing the compute task, selecting a task plan based on a result of the evaluation and the one or more routing scores, and executing the compute task by dispatching steps of the compute task to hardware resources of the compute environment according to the task plan.

In some embodiments, the method includes persisting the task plan as a versioned plan artifact that references an earlier plan version corresponding to the base task plan and storing a delta record encoding step-level modifications relative to the earlier plan version.

In some embodiments, the method includes storing the versioned plan artifact as a record of predicted execution characteristics and resource bindings.

In some embodiments, the method includes, after executing the compute task, comparing measured execution outcomes to predicted execution characteristics recorded in the versioned plan artifact and updating at least the adaptive synaptic weights of the neuromorphic model based on the comparison.

In some embodiments, the one or more task plan variant differs from the base task plan by at least one of sub-task sequencing, resource type, geographic location, energy consumption or policy constraint.

In some embodiments, the neuromorphic model generates the one or more routing scores from learned past task execution outcomes and real-time telemetry of hardware resources that function as simulated input currents to the neuromorphic model weighed against the elements of the compute task represented as simulated task neurons using a spiking-neuron state comprising leaky-integrate-and-fire accumulation, and updates adaptive synaptic weights using spike-timing-dependent plasticity based on further observed task execution outcomes.

In some embodiments, at least a portion of child nodes of the decision-tree model represent different potential task sharding strategies.

In some embodiments, at least a portion of child nodes of the decision-tree model represent currently available hardware resource pools.

In some embodiments, selecting the task plan includes choosing an task plan variant associated with a child of a root with a maximum number of node visits, or a second task plan variant associated with a maximum cumulative reward divided by a number of times that a node was visited, wherein the first and second task plan variants represent at least respective sets of hardware resources to which the compute task may be routed for task execution.

In some embodiments, to select the final plan, the decision-tree model performs a four-phase routing decision process including a node selection phase, an expansion phase, a simulation phase, and a backpropagation phase.

In some embodiments, the simulation phase includes estimating execution time and resource utilization based on a heuristic of task complexity divided by resource capacity.

In some embodiments, the backpropagation phase includes backpropagating rewards from simulations of the simulation phase to update the statistics of parent nodes.

In some embodiments, the expansion phase includes generating child nodes representing resource types and resource eligibility based on allocatable capacity.

In some embodiments, the neuromorphic model includes a plurality of task neurons mapped to task characteristics and a plurality of hardware resource neurons mapped to hardware resources.

In some embodiments, task characteristics include at least one of priority, size, resource availability, and historical latency.

In some embodiments, the hardware resource neurons are mapped to one or more of a processor type, a number of cores, a cache size, a frequency, a memory size, and a memory type.

In some embodiments, the method includes measuring execution latency while executing the compute task and re-assigning at least one remaining sub-task of the compute task to different hardware resources from the hardware resources associated with the task plan based on the measured execution latency. Reassigning the at least one remaining sub-task may be based on real-time system state or changes in system constraints and subsequent replanning of the mid-flight task execution generated by the neuromorphic model.

Embodiments of the present disclosure may be implemented by a computer system including one or more memories and one or more processors coupled with the one or more memories. The one or more processors may be individually or collectively configured to perform methods of the present disclosure. For example, the one or more processors may be individually or collectively configured to receive, via an ingress interface, a compute task, construct, by a trained decision tree machine learning model, a base task plan that associates the compute task with hardware resources of the compute environment, generate, by a neuromorphic model, one or more task plan variants and a routing score for each task plan variant based on continuously learned routing performance encoded through STDP, evaluate the base task plan together with the one or more task plan variant by executing a tree search based on one or more of predicted latency, predicted cost, predicted error risk, and predicted policy compliance of executing the compute task, select a task plan based on a result of the evaluation and the one or more routing scores, and dispatch steps of the compute task to hardware resources of the compute environment according to the task plan.

These and other embodiments will be apparent based on the following disclosure.

### BRIEF DESCRIPTION OF THE DRAWINGS

FIG. 1 illustrates an embodiment of a computer.

FIG. 2 illustrates an embodiment of an application layer and an ingress layer.

FIG. 3 illustrates an embodiment of a runtime layer or orchestrator 400 and execution layer.

FIG. 4 illustrates an embodiment of a four-phase routing decision process that may be performed by a planner.

FIG. 5 illustrates an embodiment of a process that may be performed by a task router.

FIG. 6 illustrates an embodiment of an embedding process that may be performed by an embedder.

FIG. 7 illustrates an embodiment of an annealing process that may be performed by an annealer.

FIG. 8 illustrates an embodiment of a resource plane.

FIG. 9 illustrates an embodiment of a method for executing a compute task using heterogeneous hardware resources of a compute environment.

### DETAILED DESCRIPTION

A detailed description of embodiments is provided below along with accompanying figures. The scope of this disclosure is limited by the claims and encompasses numerous alternatives, modifications and equivalents. Although steps of various processes are presented in a given order, embodiments are not necessarily limited to being performed in the listed order. In some embodiments, certain operations may be performed simultaneously, in an order other than the described order, or not performed at all.

Numerous specific details are set forth in the following description. These details are provided to promote a thorough understanding of the scope of this disclosure by way of specific examples, and embodiments may be practiced according to the claims without some of these specific details. Accordingly, the specific embodiments of this disclosure are illustrative, and are not intended to be exclusive or limiting. For the purpose of clarity, technical material that is known in the technical fields related to this disclosure has not been described in detail so that the disclosure is not unnecessarily obscured.

Embodiments of the present disclosure may implement artificial intelligence (AI) models. Artificial intelligence models used by embodiments may include gradient boosting models, random forest models, neural networks (NN), regression models, Naive Bayes models, or machine learning algorithms (MLA). An MLA or NN may be trained from a training data set.

MLAs include supervised algorithms (such as algorithms where the features/classifications in the data set are annotated) using linear regression, logistic regression, decision trees, classification and regression trees, Naïve Bayes, nearest neighbor clustering; unsupervised algorithms (such as algorithms where no features/classification in the data set are annotated) using Apriori, means clustering, principal component analysis, random forest, adaptive boosting; and semi-supervised algorithms (such as algorithms where an incomplete number of features/classifications in the data set are annotated) using generative approach (such as a mixture of Gaussian distributions, mixture of multinomial distributions, hidden Markov models), low density separation, graph-based approaches (such as mincut, harmonic function, manifold regularization), heuristic approaches, or support vector machines.

NNs include conditional random fields, convolutional neural networks, attention based neural networks, deep learning, long short term memory networks, or other neural models. While MLA and neural networks identify distinct approaches to machine learning, the terms may be used interchangeably herein. Thus, a mention of MLA may include a corresponding NN or a mention of NN may include a corresponding MLA unless explicitly stated otherwise.

The MLA may be configured or trained to predict or classify based on new inputs. Artificial NNs are efficient computing models which have shown their strengths in solving hard problems in artificial intelligence. They have also been shown to be universal approximators (can represent a wide variety of functions when given appropriate parameters). Some MLAs may identify features of importance and identify a coefficient, or weight, to them. The coefficient may be multiplied with the occurrence frequency of the feature to generate a score, and once the scores of one or more features exceed a threshold, certain classifications may be predicted by the MLA. A coefficient schema may be combined with a rule-based schema to generate more complicated predictions, such as predictions based upon multiple features. For example, ten key features may be identified across different classifications. A list of coefficients may exist for the key features, and a rule set may exist for the classification. A rule set may be based upon the number of occurrences of the feature, the scaled weights of the features, or other qualitative and quantitative assessments of features encoded in logic known to those of ordinary skill in the art.

In other MLAs, features may be organized in a binary tree structure. For example, key features which distinguish between the most classifications may exist as the root of the binary tree and each subsequent branch in the tree until a classification may be awarded based upon reaching a terminal node of the tree. For example, a binary tree may have a root node which tests for a first feature. The occurrence or non-occurrence of this feature must exist (the binary decision), and the logic may traverse the branch which is true for the item being classified. Additional rules may be based upon thresholds, ranges, or other qualitative and quantitative tests.

When exploring large amounts of unlabeled data, unsupervised methods are useful for binning/bucketing instances in the data set. A single instance of the above models, or two or more such instances in combination, may constitute a model for the purposes of models, artificial intelligence, neural networks, or machine learning algorithms, herein.

In various embodiments, components may comprise purpose-trained machine learning agents, including but not limited to large language model architectures, reinforcement learning agents, neuromorphic models, or hybrid systems. Such agents are trained specifically for infrastructure control and may not generate natural language outputs for end users.

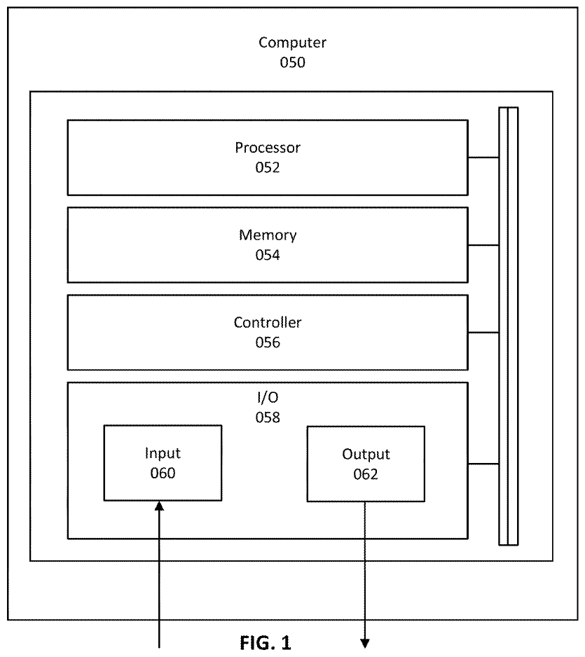

Processes of the present disclosure may be performed by one or more hardware devices such as a computer 050 as illustrated in FIG. 1, or computer system. A computer 050 may include a processor 052, a memory 054, a controller 056, and an input/output (I/O) 058. The processor 052, the memory 054, the controller 056, or various combinations thereof or various components thereof may be examples of hardware for performing various aspects of the present disclosure as described herein. These components may be coupled (e.g., operatively, communicatively, functionally, electronically, electrically) via one or more interfaces. In some embodiments, the computer (or computer system) 050 may be associated with a heterogeneous processing environment such as a data center or research facility.

The processor 052, the memory 054, the controller 056, the I/O 058 or various combinations or components thereof may be implemented in hardware (e.g., circuitry). The hardware may include a processor, e.g., a central processing unit (CPU), a digital signal processor (DSP), a graphics processing unit (GPU), a tensor processing unit (TPU), a quantum processing unit (QPU), a neural network (NN), an application-specific integrated circuit (ASIC), a field programmable gate array (FPGA) or other programmable logic device, or any combination thereof configured as or otherwise supporting a means for performing the functions described in the present disclosure.

The processor may include an intelligent hardware device (e.g., a general-purpose processor, a DSP, a CPU, a GPU, a TPU, a QPU, an NN, an ASIC, an FPGA, or any combination thereof). In some implementations, the processor may be configured to operate the memory. In some other implementations, the memory, GPU or TPU may be directly integrated into the processor. In some embodiments, the processor may be implemented as a component of a system on chip (SoC). The processor may be configured to execute computer-readable instructions stored in the memory to cause the computer to perform various functions of the present disclosure.

The memory 054 may include volatile or non-volatile memory. The memory 054 may store computer-readable, computer-executable code including instructions when executed by the processor 052 cause the computer to perform various functions described herein. The code may be stored in a non-transitory computer-readable medium such as the non-volatile memory or another type of memory 054. Computer-readable media includes both non-transitory computer storage media and communication media including any medium that facilitates transfer of a computer program from one place to another. A non-transitory storage medium may be any available medium that may be accessed by a general-purpose or special-purpose computer 050.

In some implementations, the processor 052 and the memory 054 coupled with the processor 052 may be configured to cause the computer 050 to perform one or more of the functions described herein (e.g., executing, by the processor 052, instructions stored in the memory 054).

The controller 056 may manage input and output signals for the computer 050. The controller 056 may also manage peripherals not integrated into the computer 050. In some implementations, the controller 056 may utilize an operating system such as macOS®, LINUX®, WINDOWS®, or other operating systems. In some implementations, the controller 056 may be implemented as part of the processor 052.

The I/O 058 may include hardware devices for inputting and outputting electrical, optical or radio frequency (RF) signals through an input 060 and an output 062. Examples of devices that may be present in I/O 058 include an ethernet interface, a fiber-optic interface, a PCI-Express interface, an XFI interface, an RF transceiver such as a BLUETOOTH®, Wi-Fi, or cellular telecommunications transceiver, etc.

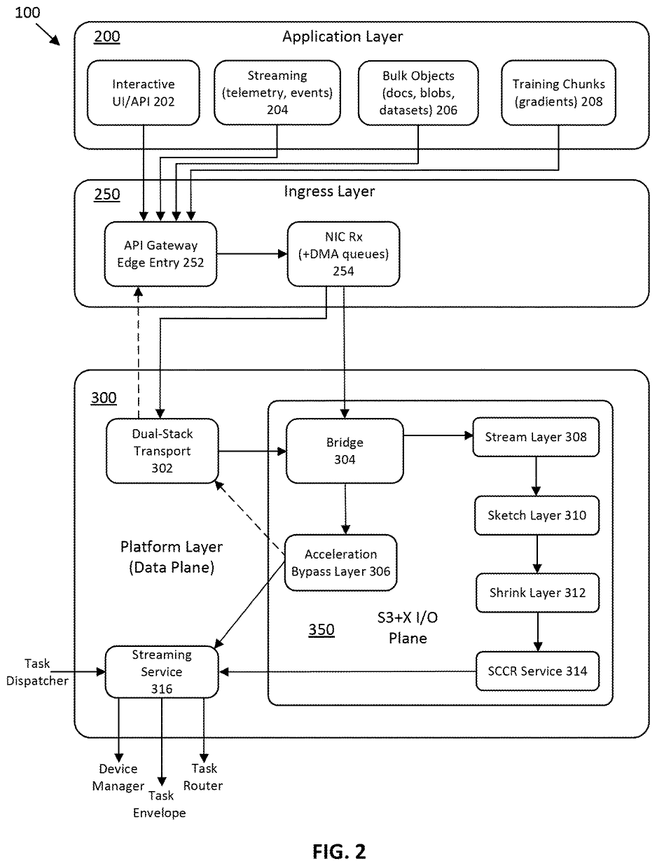

FIG. 2 illustrates an application layer 200 and an ingress layer 250 of a system 100 according to an embodiment of the present disclosure. The application layer 200 may be a user-facing layer which may receive data input from a user of the system 100. The application layer 200 may include one or more interface such as an application programming interface (API) or use interface (UI). For example, the application layer 200 may include an interactive UI 202, which may be a web-based UI, an Integrated Development Environment (IDE) plugin or dedicated development interface. In addition or as an alternative, the interactive UI/API may include an API which may receive inputs from agents or an external software application. In FIG. 2, the lines and arrows are only a general representation of some of the communication paths that may be present, and numerous additional communication paths for transmitting and receiving information between elements of system 100 are possible.

In some embodiments, the application layer 200 includes a streaming interface 204. The streaming interface 204 may be configured to receive data, e.g., telemetry or event data, which is streamed by a user to the system 100. The application layer 200 may include a bulk object interface 206 through which objects such as documents, blobs or datasets may be input into the system 100, and a training chunk interface 208. The training chunk interface 208 may be configured to receive training chunks which are streamed or uploaded to a specific training endpoint. The training chunks may include gradients, for example.

Data input through the application layer 200 may be received through an ingress layer 250. The ingress layer 250 may include an API gateway/edge entry 252 at which remote procedure calls (e.g., gRPC) or representative state transfer (REST) requests are received, deserialized, and protected by extended Berkeley Packet Filter/eXpress Data Path (eBPF/XDP) kernel-level rate limiting. Requests are distributed to a network interface controller (NIC) receiver 254. In some embodiments, the NIC receiver 254 may filter XDP eligible data utilizing Address Family XDP (AF_XDP) to achieve a partial kernel bypass.

The input data may be associated with one or more compute task which is executed by heterogeneous hardware. Examples of the input data and compute tasks are data for High-Performance Computing (HPC), e.g., scientific simulations, weather forecasting; Quantum computing, including hybrid quantum-classical workloads; Machine learning, e.g., training data for an MLA; Financial Services, e.g., real-time trading or risk analysis; Healthcare, e.g., drug discovery and genomics analysis; Autonomous systems, e.g., real-time decision-making for vehicles or robots; Edge computing, e.g., distributed inference on edge devices; and Cloud computing, e.g., multi-tenant resource orchestration. Accordingly, a system 100 may be associated with or incorporated into a heterogeneous compute environment such as a data center, research facility, supercomputer, hyperscale facility, or high performance computing (HPC) environment, for example.

The system 100 may further include a platform layer 300, which may also be referred to as a data plane 300. The platform layer 300 may include a dual-stack transport 302 which receives Transmission Control Protocol/Internet Protocol (TCP/IP) data from NIC 254 and a bridge 304 which receives XDP eligible data. In some embodiments, XDP eligible data is transmitted directly to the bridge 304 bypassing the dual-stack transport 302, while XDP ineligible data may be transmitted to the dual-stack transport 302 for regular processing.

The term “S3+X” refers to a multi-functional I/O plane 350 with multiple layers, each of which corresponds to certain functions of the system 100. “S3” refers to the three functions of stream, sketch, and shrink, and “X” refers to a hardware-accelerated kernel bypass and data plane. This layer is shown as acceleration layer 306, or an acceleration bypass layer 306. While the present disclosure adopts S3+X terminology for convenience of description, it should be understood that each of the layers of an S3+X I/O plane 350 of platform layer 300 may be referred to using different terminology as apparent from the following discussion.

The dual-stack transport 302 may serve as the foundational stream layer (e.g., Layer 1) of the platform layer 300, providing the primary communication stratum for the system 100. Platform layer 300 may be engineered for ultra-low latency and maximum reliability by leveraging modern network protocols and quantum-safe security. Platform layer 300 may also provide live path metrics to metrics systems for performance monitoring and for decision engine inputs.

The system 100 may employ a dual-stack approach to ensure data can move efficiently across diverse network environments. The dual stack approach of dual-stack transport 302 refers to a primary transport and a fallback transport.

For the primary transport, the system 100 may default to using gRPC remote procedure calls over HTTP/3, which may use a protocol such as the quick User Datagram Protocol (UDP) internet connections (QUIC) protocol. This allows for zero round-trip time (0-RTT) connection establishment, enabling immediate data transfer without waiting for multiple handshake cycles. It may also support multipath data transmission and the BBRv3 congestion control algorithm to maximize throughput.

The fallback transport may be used for environments where QUIC is not supported or network conditions are suboptimal. In this case, the system 100 may implement an automatic fallback to HTTP/2 over TCP, which may ensure consistent compatibility without sacrificing modern security standards. By utilizing HTTP/3 and QUIC, the system 100 may achieve a 4× speedup in p95 latency compared to standard HTTP/2 over TCP, for example.

The dual-stack transport 302 may employ security protocols to protect data against both current and future cryptographic threats. Accordingly, the dual-stack transport 302 may use a security protocol such as transport layer security protocol TLS 1.3, for example, to provide an efficient encryption framework.

In some embodiments, the system 100 may utilize a hybrid model specifically designed to be resistant to quantum computer-based attacks. For example, the system 100 may employ Dilithium-3 for digital signatures and Kyber-768 for key encapsulation, meeting National Institute of Standards and Technology (NIST) Federal Information Processing Standards (FIPS) for post-quantum safety. These protocols may be implemented by the dual-stack transport 302.

The dual-stack transport 302 may be configured for high-volume, real-time workloads. For example, the system 100 may maintain connection pooling of 10-100 connections per endpoint, utilizing round-robin load balancing to distribute traffic and prevent bottlenecks. TLS and encryption validation may occur at wire-speed, taking less than 1 ms, for example.

The dual-stack transport 302 may communicate with the API gateway/edge entry 252 as a return path and may transmit data to the bridge 304.

The bridge 304, which may also be referred to as a unified data plane bridge, acts as an intelligent interface between the high-level orchestration decisions made by an orchestrator 400 and the physical hardware execution paths. The bridge 304 may perform priority-based transport path selection and ensure that tasks adhere to their specific service level objectives (SLOs).

The bridge 304 may execute routing strategies determined by a planner 404 and neuromorphic decision engine/task router 406 to move data from ingestion points to their final processing or storage destinations.

The bridge 304 may classify incoming data into a priority level and map them to the most efficient transport mechanism available based on the priority level. For example, the bridge 304 may classify incoming data into one of the following four priority levels: 1) Maximum priority, 2) High priority, 3) Normal priority, and 4) Low priority. In this example, maximum priority data may be routed using an XDP or AF-XPD fast lane, which may use the eBPF-based pre-kernel classifier and XSKMAP steering for a direct User-space MEMory (UMEM)-to-storage path. High priority data may be routed using io_uring Zero-Copy. In particular, high priority data routing may leverage an asynchronous io_uring subsystem with Submission Queue Polling (SQPOLL) to minimize system call overhead. Normal priority data may be routed using sidecar transport, which may employ least common denominator (LCD) NIC abstraction for cross-cloud compatibility and shared memory Inter-Process Communication (IPC). Low priority data may be routed using a standard kernel stack. For example, normal priority routing may fall back to a standard Linux TCP/IP stack for basic compatibility.

Beyond simple routing, the bridge 304 may act as a dynamic traffic monitor to maintain system stability. For example, the bridge 304 may implement path upgrading, in which the bridge continuously monitors p99 latency for every flow. If measured latency reaches 90% of its SLO threshold, the system may automatically upgrade the flow to a faster transport path (e.g., moving from the kernel stack to the XDP fast lane). The bridge 304 may implement graceful degradation and failover in which, if a preferred transport path becomes unavailable or fails, the bridge 304 automatically fails over to the next best available path (e.g., XDP>io_uring>Sidecar>Kernel), maintaining connectivity with degraded performance rather than a total system halt. The bridge 304 may further implement zero-copy integration, in which the bridge ensures that data moving through these paths remains in a zero-copy state whenever possible, coordinating UMEM frames and io_uring linked operations to avoid CPU-intensive memory copies.

The bridge 304 may transmit XDP eligible data to an accelerated bypass layer 306. The accelerated bypass layer 306 may serve as a hardware-accelerated partial kernel bypass and data plane configured to eliminate the overhead of the standard Linux operating system stack to achieve ultra-low latency and massive throughput for quantum-inspired and machine learning workloads if validated for partial kernel bypass.

The accelerated bypass layer 306 may include one or more of three primary technology pillars.

The first technology pillar is eBPF XDP and XSKMAP steering. This component acts as a pre-kernel packet classifier that operates at a NIC driver hook. An eBPF program (e.g., xdp_fastlane) inspects incoming packet headers at wire-speed before they are processed by the kernel. The system 100 may utilize a specialized eBPF map called an XSKMAP (e.g., BPF_MAP_TYPE_XSKMAP). This table maps hardware receive queue indices directly to user-space socket descriptors. This steering mechanism may achieve sub-microsecond (<1 μs) packet steering latency and provide kernel-level protection with 30 ns latency checks, for example.

The second technology pillar is AF_XDP and Zero-Copy. UMEM AF_XDP is a user-space socket that receives packets redirected by the XDP program. A zero-copy mechanism may employ a UMEM ring buffer architecture which allows the NIC hardware to perform Direct Memory Access (DMA) directly into application-space memory frames. To maximize performance, UMEM frames are allocated from 2 MB or larger pages to reduce Translation Lookaside Buffer (TLB) misses and utilize lock-free ring buffers for wait-free packet handoffs. Such an implementation may have a benefit of eliminating the standard 2-4 μs context switches and multiple kernel buffer copies (NIC→kernel→socket→user) typical of conventional networking.

The third technology pillar is an io_uring subsystem. In some embodiments, the accelerated bypass layer 306 may optionally integrate io_uring to provide a unified asynchronous I/O pipeline for both network and storage operations. The io_uring subsystem may implement a zero-copy send by using the IORING_OP_SEND_ZC operation, which pins application memory pages so the NIC can read directly from them during transmission. The io_uring subsystem may implement an SQPOLL mode, which enables syscall-free I/O where a dedicated kernel thread polls the submission queue, allowing the application to submit data without the overhead of a standard system call. In addition, the io_uring subsystem may implement chain IO, in which the io_uring subsystem creates a disk-to-network pipeline using IOSQE_IO_LINK, allowing data to stream from persistent storage to the network without CPU-mediated data movement.

The stream layer 308 may serve as the primary transport and communication foundation for the system 100, and be configured for ultra-low-latency data distribution across heterogeneous resources. The stream layer 308 may be the first stage of the integrated S3+X I/O plane 350, and receive data from the dual-stack transport 302 and distribute that data to other layers of the S3+X I/O plane 350.

The stream layer 308 transports primitives that may include gRPC/HTTP3/HTTP2, connection pooling and secure transport, manages how data physically moves through the system 100, and may use a dual-stack transport approach as discussed above. The stream layer 308 may serve as a transport path for one or more system operations. For example, the stream layer 308 may perform data ingestion as the primary entry point for client requests arriving at the API gateway 252 via gRPC or REST endpoints. The stream layer 308 may perform task distribution by assigning inter-node task distribution, metrics collection, and audit log replication to messaging and replication components downstream. The stream layer 308 may facilitate distributed training, and in particular, may support pathways-style multi-host training by streaming tensors between nodes with high efficiency.

The sketch layer 310 is the second stage of the S3+X I/O plane 350 and may serve as the system's semantic data reduction engine. The sketch layer 310 may be configured to summarize potentially massive streams of metrics and logs into memory-efficient, probabilistic data structures, which may be referred to as sketches, that preserve critical statistical properties while reducing data volume. Accordingly, the sketch layer 310 may generate a plurality of sketches of input data. For example, sketch layer 310 may provide a 50-90% reduction in data size before transmitting the data to shrink layer 312 where further compression is applied.

The sketch layer 310 may perform one or more processes for various statistical tasks. For example, the sketch layer 310 may apply Count-Min Sketch (CMS) to summarize large amounts of data, e.g., for heavy hitter detection. In an embodiment, the CMS applied by the sketch layer 310 may operate with a width (w) of approximately 1000 and a depth (d) of 5 to maintain high accuracy with minimal memory, for example.

The sketch layer 310 may apply HyperLogLog (HLL) for cardinality estimation (e.g., counting unique items). An embodiment may apply HLL with 14-bit precision, allowing for highly accurate counts of unique events across distributed nodes. In some embodiments, the sketch layer 310 may apply t-digest for tail quantile optimization. The t-digest may be configured with a compression factor of 100, which is highly effective for tracking p95 and p99 latencies across the cluster. In some embodiments, the sketch layer 310 may apply KLL Quantiles to provide memory-efficient quantile tracking, which may be used for monitoring the distribution of task execution times without storing every individual data point.

The sketch layer 310 may use various techniques to optimize the generation of sketches. The sketch layer 310 may use one or more MLA to optimize performance rather than simply applying all sketches simultaneously. For example, sketch layer 310 may use an MLA such as LinUCB Contextual Bandit to adaptively select an optimal sketch for a specific workload. The LinUCB Contextual Bandit selection engine may identify the most efficient sketch for a given data type. Of course, other MLAs are possible.

The sketch layer 310 may replicate some or all sketch summaries across a plurality of computing nodes (e.g., a plurality of CPUs, TPU's and/or GPUs) to ensure strong consistency and fault tolerance in the event of a node failure. The sketch service may be engineered for high-performance environments, capable of handling over 100,000 operations per second per node, for example.

In the end-to-end data flow (e.g., for sentiment analysis or quantum-inspired circuits), the sketch layer 310 may intervene after the initial data stream is established but before the data is compressed for transit. By semantically reducing the data, sketch layer 310 ensures that the most important statistical features of the workload are communicated to the orchestrator 400 with minimal overhead, facilitating O(1) scheduling complexity of the system 100.

Accordingly, embodiments may employ sketch-first processing prior to full materialization. Benefits of the sketch layer 310 may include early discarding of data, a reduced memory footprint, and an overall reduction in resources resulting from a reduced/more efficient data stream transmitted to shrink layer 312.

The shrink layer 312 is the third stage in the S3+X IO plane 350. It is the primary byte-level compression engine within the system 100, and may be responsible for achieving an additional 15-25% reduction in data size after initial semantic reduction is performed by sketch layer 310, for example.

The shrink layer 312 may use a compression algorithm such as zstd (Zstandard) as a primary compression method. The application of zstd by shrink layer 312 may be characterized by two specialized technical features. The first feature is the use of per-endpoint dictionaries. The service maintains trained dictionaries of 64-128 kibibytes (KiB) for each endpoint. These dictionaries may be trained on recent payloads, allowing the system to recognize recurring data patterns specific to that endpoint and compress them much more efficiently than generic algorithms.

The second feature may be adaptive compression levels. For example, the shrink layer 312 may dynamically adjust compression intensity, e.g., ranging from L3 to L6, based on current system requirements and observed performance. Accordingly, the shrink layer 312 may monitor performance and adapt compression intensity using, for example, machine learning. The machine learning used by shrink layer 312 may be based on an MLA such as ZPD-Bandit, which may serve as a per-endpoint policy selector.

In some embodiments, the machine learning process may implement contextual decision making. For example, shrink layer 312 may use a LinUCB contextual bandit decision engine to choose an optimal compression strategy from a set of available policies (e.g., {none, zstd L3, zstd L6, zstd L6+dict}). Of course, other embodiments of the set of available policies are possible.

Shrink layer 312 may implement continuous learning for compression. For example, the machine learning process may update its policy on a periodic basis, e.g., every 100 requests. The continuous learning may operate on an exploration and exploitation basis, where a first portion of the compression is performed using a current policy (exploitation), and a second and smaller portion of the compression is performed using a different policy (exploration). For example, the first portion of the compression may be performed for about 80 to 95% of compression requests, and the second portion of the compression may be performed for about 20 to 5% of the requests to test different policies. The amount of time spent in exploration may vary based on various factors such as the number of policies, the continuity of data, maturity of the system, etc. When the continuous learning process determines a more effective compression result using a policy in exploration, that policy may be implemented as the primary policy for the next set of compression requests.

Shrink layer 312 may implement a reward function. In such an embodiment, a selection may be refined through a Spike-Timing-Dependent-Plasticity (STDP) update where the MLA calculates the difference between predicted and actual rewards, such as compression ratio or latency impact, to adjust future decisions.

In the end-to-end processing pipeline, the shrink layer 312 may compress data after sketches are generated by the sketch layer 310 and transmit compressed data to a SCCR SLO-Constrained Coalescing and Reconciliation (SCCR) service 314, as illustrated in FIG. 2. In another embodiment, the shrink layer 312 may operate after data has been batched by SCCR service 314.

The SCCR service 314 is a performance-tuning component within the data plane/platform layer 300. The SCCR service 314 may also be referred to as a service level objective (SLO) constrained coalescing and batching (e.g., micro-batching) service. SCCR service 314 may batch incoming requests (coalescing) to maximize throughput while ensuring that these batches do not violate any SLOs defined for an associated task. The SCCR service may perform a service in which sketch summaries are replicated across nodes with deterministic reconciliation to converge on a versioned sketch state under concurrent updates and faults.

The SCCR service 314 may operate using a feedback loop based on queueing theory to manage the trade-off between efficiency (e.g., batch size) and speed (latency). In some embodiments, the SCCR service 314 may use Kingman-Based Latency Estimation. For example, the SCCR service 314 may use the Kingman formula to perform p99 latency estimation in real-time. By analyzing coefficients of variation for task arrival and service times, SCCR service 314 can predict the maximum possible batch size that can be processed without crossing a latency threshold.

In some embodiments, the SCCR service 314 may use an Additive Increase/Multiplicative Decrease (AIMD) batch size control. The SCCR service 314 may use AIMD to control batching. Similar to TCP congestion control, SCCR service 314 may gradually (e.g., additively) increase the batch size to improve throughput, and shrink the batch size at a higher rate (e.g., multiplicatively) when measured p99 latency approaches the SLO target. The SCCR service 314 may also implement micro-batching in which small requests are grouped into micro-batches. Here, a small request may refer to requests having a payload size and/or expected processing cost below one or more configurable thresholds.

For example, the small requests may be requests below a threshold byte size, requests predicted to complete within a threshold time budget, or requests involving fewer than a threshold number of segments or keys. Accordingly, embodiments may perform one or more of comparing request sizes (in bytes) to a threshold value, predicting an execution time of a request, and/or comparing one or both of a number of segments or keys of a request to a threshold value to determine whether a request is to be grouped into a micro-batch. By grouping small requests into micro-batches, overhead associated with per-task context switching and syscalls may be reduced.

The SCCR service 314 may serve as a bridge between data arrival and the execution workers. In some embodiments, the service may be integrated with a pool such as ANTS v2 multipool, which may handle the actual execution of the batched tasks across concurrent goroutines.

The SCCR service 314 may also perform reconciliation. For example, the SCCR service 314 may generate a reconciliation protocol, which may be executed by sketch layer 310 to maintain replicated sketch summaries across a plurality of nodes. In an embodiment, the SCCR service 314 enables nodes to accept sketch updates and replicate those updates while tolerating concurrency and partial failures by detecting divergence between replicas using versioned vectors +Merkle-hash ranges, exchanging compact deltas, and applying deterministic merge rules to converge on a reconciled sketch state. The reconciliation step may include operations that (i) identify a conflicting or non-aligned sketch state between nodes, (ii) compute or request a minimal set of differences for synchronization, and (iii) resolve and merge such differences into a versioned, authoritative sketch artifact that can be used for subsequent processing and/or binding execution.

The SCCR service 314 may prepare task batches and transmit the task batches to streaming service 316 for buffering, replication and admittance to control plane/orchestrator 400. The streaming service 316 may serve as a durable, distributed message bus and primary task queuing mechanism within a messaging and routing layer of the system 100.

In an embodiment, the streaming service 316 may be implemented by a NATS server with JetStream enabled. The streaming service 316 may provide a decoupled, near-real-time data exchange that allows various agents and orchestrators to publish and subscribe to data as events across different environments and locations.

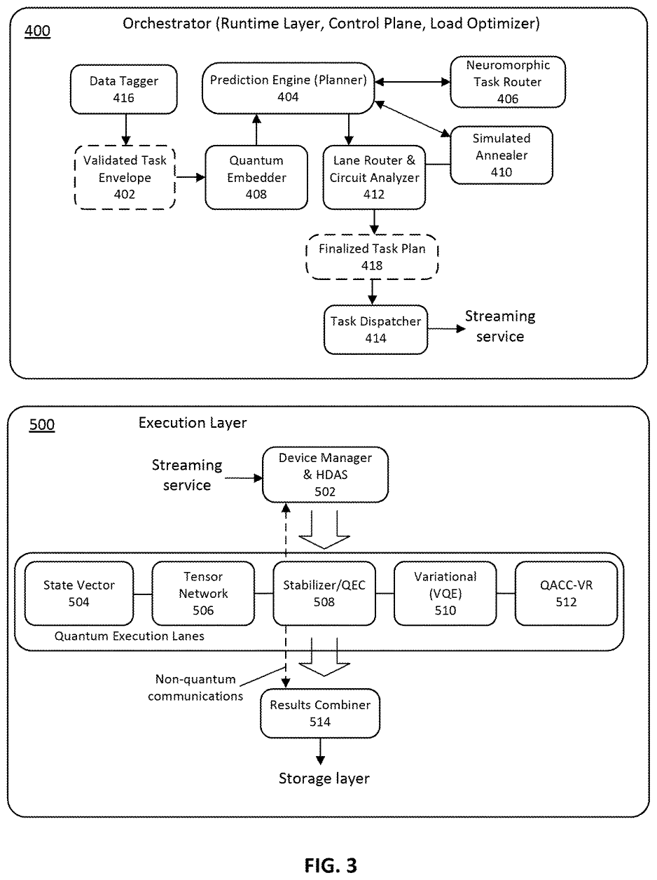

FIG. 3 illustrates an embodiment of a runtime layer or orchestrator 400 and execution layer 500 of a system 100. The orchestrator 400 may also be referred to as an agentic task orchestrator, a global task orchestrator, a runtime layer, a load optimizer, or more generally, an orchestrator. The orchestrator 400 may analyze incoming tasks or circuits and coordinate execution decisions across a plurality of execution lanes of execution layer 500. The orchestrator 400 may evaluate the current system state, task characteristics, and historical performance metrics to guide routing and hardware resource allocation.

An orchestrator 400 may replace a conventional load balancer in a heterogeneous computing environment. Conventional load balancers typically operate using an algorithm to assign compute resources to processing tasks in a process queue or pipeline to balance the execution of those tasks across the compute resources by applying a constant processing load to those resources over time. In contrast, an embodiment of an orchestrator 400 may perform load optimization by determining an allocation of resources for the execution of tasks before those tasks are submitted to a streaming service 316. This functionality represents a substantial advancement in the execution of compute tasks, increasing the efficiency in terms of time, energy and cost, compared to conventional load balancing and task execution in heterogeneous computing environments.

The term “task” may refer to a unit of work submitted to the system 100, including data processing requests, model inference requests, training operations, optimization problems, quantum or quantum-inspired circuit executions, agent invocations, interactive requests, streaming events, or computational circuits, for example. A task may be decomposed into sub-tasks or executed as a single unit.

A task envelope 402, which may also be referred to as a task structure, may refer to a structured record that defines requirements and identity for a task, including fields such as ID, type, priority, processor requirements, memory requirements, timeouts, and metadata including SLO, cost constraints, processing location, and compliance requirements, for example. Additional features that may be present in a task envelope 402 will be apparent to persons of skill in the art and from the present disclosure. Examples of processor requirements may include one or more of a processor type (e.g., CPU or GPU, or specific models of processors), processor characteristics (e.g., a minimum processor speed in GHz, a minimum or maximum number of cores, cache size, etc.). Examples of memory requirements include memory speed, bandwidth, type (e.g. HBM, SRAM, DRAM), a maximum or minimum memory size (e.g., in gigabytes), etc. Examples of compliance requirements may include compliance with applicable regulations such as Payment Card Industry Data Security Standard (PCI-DSS), General Data Protection Regulation (GDPR), California Consumer Privacy Act (CCPA), Health Insurance Portability and Accountability Act (HIPAA), energy-related regulations, data security, etc). A task envelope 402 may have two states: a base state, and an enriched state in which task plan and dispatch plan data are added to the envelope.

A runtime layer may refer to a runtime architecture, e.g., the live execution environment and control mechanisms that operate during task execution, including analysis of incoming tasks or circuits, selection of execution strategies, scheduling and routing decisions, binding to heterogeneous computing resources, and measurement of execution outcomes for adaptive improvement. Runtime architecture may govern how work is executed in real time, as opposed to how requests are submitted or persisted. An orchestrator may refer to one or more runtime components that analyze tasks or circuits and coordinate execution decisions using one or more decision-making techniques, including but not limited to Monte Carlo Tree Search (MCTS), neuromorphic routing models, quantum-inspired embeddings, and simulated annealing. The orchestrator 400 may evaluate system state, task characteristics, and historical performance to guide task routing and execution.

The orchestrator 400 may be a control-plane mechanism configured to analyze incoming tasks and coordinate execution decisions across specialized modules and execution lanes, and generate a dispatch plan. A dispatch plan may be a machine-readable artifact that governs one or more execution bindings, including selected node(s) or lane(s), ordering and concurrency constraints, retry or escalation policies, and one or more budgets and limits enforceable by downstream runtime components that governs node selection, concurrency settings, and budget allocations. A dispatch plan may indicate a queue or queue-based topic to use for executing a task, and address the queue to which a task travels to resources indicated by a task plan. Execution lanes may include one or more differentiated transport or compute paths (e.g., a kernel-bypass ingress path, a standard kernel networking path, CPU-only execution, GPU-accelerated execution, or isolated compliance domains), each of which may be associated with distinct latency, throughput, and policy characteristics.

The orchestrator 400 may receive a validated task envelope 402 indicating an interactive SLO (e.g., p99 latency below a threshold value) and a threshold. In an embodiment, the orchestrator 400 may classify the task as requiring retrieval and structured verification, decompose the task into (a) retrieval, (b) reasoning, and (c) verification subtasks, and select (i) a low-latency execution lane for retrieval, (ii) a primary reasoning module with a first token budget, and (iii) a verification module with a bounded retry policy.

The orchestrator 400 may feeds raw task features to an embedder 408 for similarity reduction and task clustering assignment, which may become part of task envelope constraints used to initialize a root node of a planner 404. Once the planner 404 has completed its analysis and planning with input from the router and annealer, the orchestrator 400 then combines the finalized dispatch plan into the task envelope 402, sets a concurrency limit for parallel retrieval operations, and transmits a versioned dispatch plan to a task dispatcher 414 that includes node identifiers, concurrency settings, and other constraints. During execution if a performance metric or resource state change result in task execution falling below SLO thresholds (e.g., latency, cost) or a policy change results in task invalidation, the dispatch plan permits mid-flight replanning of the task within new resource allocations or policy constraints. Examples of these and other features will become apparent in view of the following discussion.

Although elements of FIG. 3 are numbered sequentially for clarity, various operations of the orchestrator 400 may occur concurrently and in parallel, and various components may execute operations related to the same task or task envelope in parallel. As in FIG. 2, the lines and arrows of FIG. 3 are only a general representation of some of the communication paths that may be present in an embodiment, and numerous additional communication paths for transmitting and receiving information between elements of system 100 are possible.

The orchestrator 400 may be an agentic decision engine that generates and operates a plurality of agentic sub-routines with specific training and instructions, and that utilize one or more integrated decision-making modules to optimize workloads. Five such modules are shown in FIG. 3. Each of these agentic sub-routines may be associated with a different component of the orchestrator 400. For example, each of the planner 404, task router 406, quantum embedder 408, simulated annealer 410, and lane router 412 may generate and execute an agentic sub-routine for each compute task submitted to the orchestrator 400. Each of these agents may be generated and run for each task, and terminate after task execution. While the agents themselves may terminate, metrics and analysis associated with the agent and task execution may be retained by the system 100 (e.g., stored in a memory 054) and retrieved by subsequent agents for continuous improvement of task execution.

The first module is a quantum-inspired embedder, which may be referred to as a quantum embedder 408. The embedder 408 receives raw task features that may include workload size, precision requirements, resource affinity, latency constraints, historical execution patterns and compresses these into a low-dimensional task vector via PCA/superposition encoding. It then computes [symbol] ψ|φ [symbol] inner-product similarity against known task archetypes (previously seen workloads) and maps them into similarity space using quantum-like transformations. The embedder 408 may further reduce task dimensionality by interpreting flat vectors as amplitudes of a quantum-style state that allows operations in a log₂(N) coordinate state. These embeddings allow the system 100 to predict system states and create similarity cluster assignments that may become part of a constraint (or task) envelope payload that initializes a root node for the planner 404.

The second module is a prediction engine or planner 404. The prediction engine/planner 404 may perform tree search simulations to create a base task plan, and evaluate additional candidate task plans or task plan variants and scheduling actions. The prediction engine/planner 404 may identify near-optimal strategies by predicting potential task execution outcomes relative to system load and SLO constraints. The prediction engine/planner 404 may use MCTS to aid prediction, for example, but embodiments are not limited to MCTS, and other search tree structures may be used by the planner 404 in some embodiments. The prediction engine/planner may further supply a base task plan to other coordinating modules.

A task plan may be an output from the planner 404 that includes associations between hardware resources and elements of a task that are to be executed by those resources. For example, a task plan may indicate one or more hardware resources, task shards that are to be executed by those hardware resources, and operational parameters of the hardware resources (e.g., operating frequency, bandwidth, voltage, power, memory allocation, etc.) that are to be used for the task execution.

A task plan may be different from a dispatch plan, which may be a transport-bound execution task artifact. For example, a task plan may include instructions and information for which resources execute a task and execution parameters for that execution, and a dispatch plan may address how a task is transported. In particular, a dispatch plan may indicate a queue by which a task travels to resources defined by a task plan.

The third module is a neuromorphic task router (NTR) or task router 406. In some embodiments, the task router 406 may analyze a base plan provided by the planner 404 and compare elements of the base plan to historical routing performance characteristics of similar tasks as represented in a neural net. Task router 406 may use leaky integrate-and-fire (LIF) neurons and spike-timing-dependent-plasticity (STDP), to provide adaptive task plan variants to the planner 404 that may provide faster convergence, more efficient MCTS explorations, and contextual system memory of successful routing decisions. Task router 406 may re-weight synaptic connections between pre-synaptic and post-synaptic neurons in real-time based on observed traffic patterns, changes in system states or policies, and historical success rates using STDP to continuously refine operations.

The fourth module is a simulated annealer 410, which may also be referred to as a simulated annealing optimizer. The simulated annealer 410 analyzes the base plan provided by the planner 404 and may further refine task plans by optimizing for lower energy in the task execution; it may define energy as a scalar cost function that may represent latency, power and cost vectors; and may use that function to explore and settle on and propose task plan variants to the planner 404 representing the most globally efficient pipeline configuration.

The fifth module is a lane router and circuit analyzer, which may also be referred to as lane router 412. This module may select an appropriate execution lane, such as State-Vector, Tensor-Network, Stabilizer/QEC, Variational Quantum Eigensolver (VQE) or Quantum-Inspired Accelerated Classical Computing with Variance Reduction (QACC-VR), based on workload characteristics, and validate the feasibility of the selected compute path. This lane router 412 may utilize advanced mathematical frameworks, for example, Multi-Level Monte Carlo (MLMC) and Optimal Computing Budget Allocation (OCBA), to minimize shot noise and improve convergence for variational algorithms.

When analysis of the base task plan, plan checkpoints, task plan variants and simulated rollouts is complete and task plan variants have been incorporated or rejected, the orchestrator 400 outputs a finalized task plan 418 to the task dispatcher 414 which may serve as a versioned artifact containing concrete execution instructions, including node selection, concurrency settings, budget allocations, and the step-wise history of task plan evolution.

Processes performed by orchestrator 400 may be continuously refined through a closed-loop feedback layer that collects telemetry, such as latency and resource utilization to update MCTS statistics and online learning via STDP for neuromorphic weights for subsequent tasks, and all feedback may be used to continuously refine the performance of the underlying decision engine model via retraining and reweighting. Elements of the orchestrator 400 will be explained in more detail below.

The creation and validation of a task envelope 402 (or task structure) may be a multi-stage process that begins at the network edge and concludes with the task being securely enqueued for orchestration. The task envelope 402 may be a data structure that defines a workload's data structure, requirements and identity. Its creation may involve several integrated components.

A task envelope 402 may be initialized or created by the orchestrator 400 at the point of ingestion, e.g., after a task is received from streaming service 316. The orchestrator 400 may read the state of system resources, and metadata of a task received by system 100 to build a core object. A task envelope 402 may include one or more fields such as an identity (ID) field which may be used by system 100 to track the task, a type field, a priority field, a processor requirements field, a memory requirements field, a timeouts field, and a metadata field, a cost constraints field, a processing location field, and a compliance requirements field, for example.

The system 100 may perform semantic analysis to extract, from metadata associated with a task, specific compute requirements such as CPU cores, GPU memory, FPGA bitstreams, or simulated qubit counts to be used for executing the task. The system 100 may also capture features such as deadlines, SLA targets, cost constraints, and compliance levels. Other task features are possible.

In some embodiments, orchestrator 400 may employ a data tagger 416 to build a task envelope 402. A data tagger 416 may use machine learning to apply multi-label categories (e.g., modality, language, urgency) to the task envelope 402. Simultaneously, when different data modalities (e.g., text, image, audio) are associated with a task, a data unifier or results combiner 514 may merge the various data modalities into a normalized, consistent schema so downstream services can consume the task without modality-specific pipelines.

The system 100 may employ a multi-tier validation pipeline to ensure only authorized and feasible tasks are processed. In an embodiment, the system may employ kernel-level protection. For example, before the data even reaches userspace, the system 100 may apply rate limiting via eBPF/XDP maps using a token bucket algorithm. The system 100 may also perform TLS/Encryption validation, verifying certificate chains against post-quantum hybrid standards such as Dilithium-3.

In some embodiments, the system 100 performs gateway validation. For example, the API Gateway 252 may perform standard checks, including schema validation, size limit enforcement (e.g., token limits), and basic authentication.

After passing these or other validation tiers, a task may be routed to streaming service 316 (as illustrated in FIG. 2), which may then stream the task to a device manager 502 of execution layer 500 which will be described in more detail below. The streaming service 316 may use a NATS JetStream queue with 3-way replication across cluster nodes to ensure consistency and fault tolerance, for example.

The prediction engine or planner 404 may be a decision engine (e.g., an MLA) that is primarily responsible for optimal resource allocation and task decomposition. By simulating potential execution paths, planner 404 identifies the most efficient way to route tasks through heterogeneous compute resources (CPU, GPU, TPU, FPGA, and QPU-simulated lanes). The planner 404 may employ MCTS or another search tree to aid in planning.

The planner 404 may operate within the orchestration pipeline and leverage multiple subcomponents, including one or more of the router 406, embedder 408, annealer 410 and analyzer 412, to bridge the gap between incoming raw data and final hardware execution.

When the task is a quantum simulation, the planner 404 may analyze circuit characteristics (such as qubit count, depth, and entanglement) to select the best of a plurality of specialized execution lanes of execution layer 500 (e.g., State-Vector or Tensor Network) in O(1) time. The planner 404 may operate in conjunction with lane router 412 for lane selection and assignment.

The planner 404 may be a dynamic planner that implements dynamic strategy discovery. Unlike static schedulers, planner 404 may explore scheduling and routing actions to find near-optimal strategies under rapidly changing system conditions, with parallel specific-objective simulations being explored by the annealer 410. In one embodiment, the planner 404 uses task plan variant outputs from the annealer 410 to verify that a candidate plan meets the task's SLOs and cost/energy constraints, and to break ties among viable paths.

In addition, planner 404 may run simulations to verify that a chosen decomposition and resource path will meet the task's specific SLOs and cost/energy constraints. The planner 404 may execute such simulations using an MCTS algorithm in which the root node is initialized with the current resource state of the entire system, checkpoints are created, and child nodes represent specific potential subtask allocation decisions or currently available hardware resource pools, including CPU, GPU, TPU, FPGA, NPU, and QPU pools, and memory pools, or potential routing lanes and sub-processing pipelines, in conjunction with the router 406 and annealer 410. The child nodes may represent routing actions, e.g., a set of hardware resources to which a task may be routed for task execution and which execute the task and those routing actions may include task plan variants proposed by the cooperating modules.

In an embodiment, a root node may be initialized as an in-memory root node structure (struct) with two payloads: a resource state payload that holds a snapshot or pointer value representing system capacity/availability by node, resource type, memory and network bandwidth; and a constraint envelope payload with decomposed task features.

The initialized struct may also include a search configuration payload (e.g., UCB1 scoring rule, exploration constants, iteration budgets), and a root statistics payload which is initialized as empty and then filled with simulated rollouts. Another component of the initialized structure may be a constraint envelope payload as extracted features including one or more of deadlines, cost/energy budgets, resource requirements, policy and compliance tags, size estimates (e.g., bytes, tokens, tool-calls), and optionally a subtask DAG if decomposition exists.

In one embodiment, the planner 404 performs a repeated five-phase cycle including: (a) selection from a root node representing current system state using a UCB1 policy; (b) creation of checkpoint nodes (c) expansion to generate children representing resources or lanes, pruning infeasible options; (d) simulation of candidate plans (including parallel simulations) estimating execution time and utilization; and (e) backpropagation updating statistics with potential rewards based on minimized latency, cost, and violations.

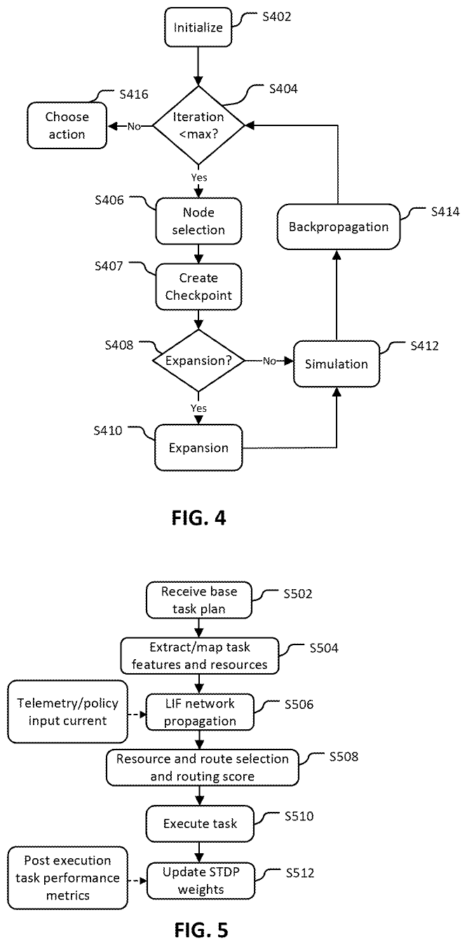

FIG. 4 illustrates an example of a five-phase routing decision process that may be performed by a planner 404. The process initialized at S402. The initialization may include setting an iteration counter to zero and selecting a root node of an MCTS tree. After initialization, an iteration counter is checked at S404 by comparing a current iteration to a maximum number of iterations (e.g., 1000 iterations), and if the number of the current iteration is less than max, then the process proceeds to node selection at S406.

Node selection at S406 may be the first phase of the five-phase cycle. Node selection at S406 may start from a root node (representing the current system state), and traverse an MCTS tree using an UCB1 (Upper Confidence Bound) formula to balance exploration of new paths with the exploitation of known efficient ones.

Checkpoints are created at S407. The checkpoints may be nodes that are treated as decision points, where the planner segments potential expansions so that additional exploration may be bound only from the checkpoint forward and so that plan variants proposed by the router 406 or annealer 408 can be explored against other nodes contained in the tree independently.

Following the creation of a checkpoint, the second phase of the process may determine whether to perform expansion at the selected node S408. Whether to perform expansion may be based on the location of a selected node. For example, if a selected node is non-terminal and/or has untried simulation rollouts, (e.g., a simulation at S412) then expansion may be determined at S408 and the process proceeds to expansion at S410. On the other hand, if the selected node is a terminal node, and/or if the node does not have any untried actions, then no expansion is performed and the process proceeds to simulation at S412.

The third phase may be an expansion phase performed at S410. In the expansion phase, planner 404 may generate child nodes representing resource types (e.g. processor types, executions lanes) and resource eligibility at the time of planning based on allocatable capacity, health/reachability, and incorporate plan variants proposed by the router 406, the annealer 410 that may better satisfy task constraints, pruning any options that lack sufficient ability to satisfy service objectives. Allocatable capacity may refer to how much capacity a resource can provide to a potential execution plan. For example, a child node may indicate “Resource type: ARM CPUxxxx” but that CPU may currently be running a task consuming 30% of the processor bandwidth, in which case the allocatable capacity is only 70%. Each expansion may represent an action that the planner 404 may choose to incorporate in the final task plan.

The fourth phase may be a simulation phase which is performed at S412. In a simulation phase, planner 404 may run a plurality (e.g., 6, 8 or 10) of parallel simulations from the expanded nodes from S410 or terminal nodes. The simulation may include estimating execution time and resource utilization based on a heuristic of task complexity divided by resource capacity, for example. Task complexity may be estimated using one or more features including an estimated token count, a predicted number of sub-tasks in a decomposition graph, a predicted number of tool calls, an estimated number of sketch segments or keys to read/write, an estimated data volume (bytes) to retrieve, and/or an estimated instruction or syscall count. Resource capacity may include allocatable compute throughput (CPU cycles/sec, GPU TFLOPS, or tokens/sec), allocatable memory (e.g., free GPU memory), allocatable I/O bandwidth (e.g., NVMe MB/s), and/or allocatable network bandwidth (e.g., Gbps), optionally adjusted by measured queue depth and current utilization.

The fifth phase may be a backpropagation phase which is performed at S414 after the simulation at S412. In a backpropagation phase, rewards from the simulations at S412 are propagated back up the MCTS tree to update the statistics of parent nodes and create another checkpoint. After backpropagation at S414, the iteration counter is incremented and the process returns to S404. Rewards may be determined by computing a utility score for a simulated rollout based on one or more objective measures (e.g. predicted latency, cost, power throughput) and applying one or more penalties for constraint violations (eg. SLO violations, budget overruns, exceeding power thresholds, infeasibility, or policy noncompliance). In an embodiment, the reward is computed as a weighted combination of normalized metrics and penalties, optionally clipped to a bounded range to stabilize learning and tree statistics.

After the maximum number of iterations are performed, an action is chosen by the planner 404 at S416. The planner 404 may choose an action associated with a child of a root with a maximum number of node visits, or an action associated with a maximum cumulative reward divided by a number of times that the node was visited. For example, after the maximum number of iterations are performed, the planner 404 selects an action by treating each child of the root as a candidate action and, during iterations, maintains for each node (or parent-child edge) a visit count defined as the number of times the node (or action) is selected, a cumulative reward defined as the sum of rollout rewards backpropagated to that node (or action), and a mean value defined as the cumulative reward divided by the visit count when the visit count is greater than zero, where each backpropagation updates these statistics by increasing the visit count by one, adding the rollout reward to the cumulative reward, and recomputing the mean value.

In an embodiment, each child of the root node is assigned a label associated with an execution strategy, which may be referred to as task sharding strategies that may be applied to a task for more efficient processing. For example, an atomic task may not be sharded, and the entire task may be assigned to one resource pool; a data-parallel sharded task may split data into n equal partitions each sent to a different resource pool; a token-range sharded task may partition ranges of tokens across devices (e.g., tokens 0-2K on GPU-A, 2K-4K on GPU-B); a pipeline-sharded task may be split into sequential stages on heterogeneous hardware: (e.g., tokenize (CPU)→embed (GPU)→rank (NPU)→post-process (CPU) Multi-modal Chain-of-Thought (CoT) with vision+language+retrieval stages); a subtask-directed acyclic graph (DAG) sharded task may be a task decomposed into a DAG of subtasks (e.g., complex agentic workflows with tool calls, where each tool call is a subtask); or a tensor-parallel shard which may split model weights across devices; and each device may compute partial activations, followed by an all-reduce operation.

The planner 404 may explore any number of child nodes that have the same sharding strategies with different resource pools.

In some embodiments, child selection during the iterations uses an exploration-aware score defined as the child's mean value plus an exploration term equal to an exploration coefficient multiplied by the square root of the natural logarithm of the parent's visit count divided by the child's visit count. After the iterations are complete the final action is chosen using a commit policy that omits exploration by selecting either the child of the root with the greatest visit count, or the child of the root with the greatest mean value (i.e., the greatest ratio of cumulative reward to visit count), optionally after excluding infeasible or constraint-violating children and breaking ties using secondary criteria such as predicted p99 latency, predicted cost, or a deterministic ordering.

Accordingly, the planner 404 may implement an iterative process of node selection, expansion, simulation and backpropagation to determine an optimal or near-optimal task plan for a task associated with a task envelope 402. The task plan may be the original base task plan, or a hybrid task plan incorporating specific-objective proposals received from the router 406 or annealer 410, and the final task plan and may be recorded in the task envelope 402 by the planner 404.

The system 100 includes a neuromorphic task router 406 configured to provide adaptive, event-driven routing and real-time allocation proposals in the form of plan variants to the planner 404, in which routing decisions improve based on observed outcomes. The neuromorphic task router 406 represents a transition away from static routing tables toward a dynamic system that learns and adapts to changing resource availability.

The task router 406 may operate by simulating biological neural processes in software to identify and compare the most historically efficient task and resource pairing and routing paths as represented in a neural network, for incoming tasks. For example, the neuromorphic task router 406 may use one or more of software-simulated Spiking Neural Networks (SNNs) and/or hardware-based SNNs to make sub-millisecond routing plan variants based on real-time system metrics. The task router 406 may learn, via online spike-timing-dependent-plasticity, from each successful and unsuccessful routing plan and reweight simulated synapses autonomously so that the next time a similar task is received the task router 406 will be faster to propose routing solutions with higher proven historical efficiency.

In some embodiments, the task router 406 simulates spiking neuron dynamics in software (e.g., Go routines) without specialized neuromorphic hardware. In such embodiments, task features (e.g., priority, size, resource availability, historical latency) are converted to input currents for simulated neurons. Neurons may be modeled using a leaky integrate-and-fire (LIF) dynamic: when a threshold is exceeded the neuron emits a spike, and a winner-take-all mechanism selects a routing decision based on the first output neuron to spike.

In some embodiments, the task router 406 maintains relationships between task neurons and resource neurons and updates synaptic weights through spike-timing-dependent plasticity (STDP). The task router 406 may create a plurality of neural maps for a given base plan provided by the planner 404. Accordingly, the task router 406 may, for each neural map created, designate a first set of neurons as task neurons and map the task neurons to task characteristics as extracted from the base task plan from the planner 404, and designate a second set of neurons as resource neurons and map the resource neurons to specific resources associated with performing tasks. The resources may be associated with a particular compute environment, e.g., a cloud-based service or a data center. The resource neurons may additionally incorporate system telemetry and state changes converted into input current that is integrated into the membrane potential of the simulated neurons.

Examples of task characteristics that may be mapped to respective task neurons include priority, size, resource availability, and historical latency. Examples of resources that may be mapped to respective resource neurons include processor type (e.g., GPU, NPU, CPU,), number of cores, cache size, processor characteristics such as frequency and speed, memory type, memory size, etc. In an embodiment, the task and resource neurons do not represent individual threads, processes or packets. Resource availability may refer to allocatable capacity of one or more resources at a given time based on current utilization, queue depth, admission-control state, capacity reservations, predicted start time, and/or measured error/health signals. Examples of resources that may be mapped to respective resource neurons include processor type like GPU, NPU, CPU, number of cores, cache size, processor characteristics such as frequency and supported precision modes, memory type and size, storage and I/O characteristics, and network characteristics. Examples of task characteristics that may be mapped to respective task neurons include, for example, priority or class of service, task type or intent, latency target, deadline, if able p95/p99 target, budget constraints such as compute/token/tool-call limits or policy constraints such as GDPR region processing restrictions. Size measures payload bytes, estimated token count, expected number of subtasks or tool calls. Data characteristics for file type/format, sensitivity or policy constraints like data locality/compliance domain, and historical performance signals which include historical latency, timeout rate, verifier pass rate.

Successful low-latency routings strengthen corresponding synapses, e.g., by long-term potentiation (LTP), while high-latency or unsuccessful routings weaken them by long-term depression (LTD). The system may feed back execution success and/or failure and latency to update synaptic weights for future decisions. Within a multi-lane execution architecture, the task router 406 helps determine which of the execution lanes (e.g., State-Vector 504 or Tensor Network 506) is optimal for a given quantum-inspired circuit.

FIG. 5 illustrates an embodiment of a process that may be performed by a task router 406. At S502, the task router 406 receives a base task plan from the planner 404. The task may include metadata which indicates a task type (e.g., inference), a task ID, a data size, and an SLO.

The task router 406 may extract task features at S504 and map at least some of those features to task neurons. The task router 406 may similarly map resources of a compute environment to resource neurons. The mapping of task features at S504 may be performed for each task, while the mapping of resources may be performed one or more times per compute environment, e.g., periodically when available resources or policies of the compute environment change.

In some embodiments, the task neurons are specific to task characteristics. Accordingly, the task router 406 may map a task type to a task type neuron, map a task size to a task size neuron, and map an SLO to a task latency neuron.

The task router 406 may propagate the task across the task and resource neurons at S506. Task propagation may include applying a LIF model to the neuron architecture. For example, membrane potential (e.g., simulated voltage derived from real-time operational telemetry may be integrated over time, and STDP-trained synapses of the task router 406 create relationships between the task neurons and the resource neurons. Spikes may propagate through weighted synapses between neurons, and hidden neurons may apply a simulated leak current based on a leak voltage.

When a task is propagated at S506, the task may be encoded into a spiking representation. When a neuron's potential exceeds a configurable threshold (e.g., −50 mV), it fires a spike. Spikes may occur when certain task or resource encodings (definitions or ‘state’) rise above a threshold that is encoded in the neuromorphic weights. In an example, a GPU that has ‘n’ number of cores in ‘x’ region, with ‘z’ cost and ‘l’ latency has been encoded in the task router 406 weights in the past as a −0.48 mV. When a task neuron is created that reaches the −0.48 mV weight/threshold when there is also a resource neuron that matches that encoded weight, that task neuron fires, and a task plan variant for the associated task and associated resource neuron are proposed to the planner 404.

A routing plan variant may be created at S508 in which the task router 406 selects one or more execution lanes and/or compute (hardware) resources based on the output from the LIF propagation at S506. The lane/resource selection may be made on a winner-take-all basis in which the first output neuron to spike selects the designated execution path or resource. The task router 406 may create routing plan variants that select resources/execution lanes for task execution based on which resource output neurons fire first in the LIF propagation at S508 and provide a routing score to the planner 404 along with the routing plan variant. The routing score may correspond to the magnitude of a spike, and represent confidence of the neuromorphic router in a variant. Accordingly, the routing score may also be generated at S508.

The routing plan variant may then be incorporated by the planner 404 into a final plan, and subsequently the task may then be executed by the orchestrator 400 using the resources and/or execution lanes selected by the task router 406 at S510.

After a task is complete, the task router 406 updates STDP weights based on characteristics of the task execution at S512. For example, characteristics such as success or failure, and performance metrics such as latency, power consumption, etc. may be measured during task execution and used to update synaptic weights of a SNN to train the SNN for future task routing decisions. For example, during routing, task characteristics may be encoded as one or more input spikes that drive downstream neuron activations, and the SNN produces an output activation pattern that corresponds to a selected routing action as a selected lane/node.

In this example, during or after execution there are one or more observed outcomes for success/failure, latency, policy violations, retries, energy or power consumption, queueing delay that are converted into a learning signal represented by a spike timing difference value; that is used to adjust synaptic weights. The learning update process records spike times observed on pre-synaptic and post-synaptic neurons for connections implicated in the selected action and applies a STDP rule. The STDP rule is gated and scaled by the learning signal, so that synapses that contributed to favorable outcomes are strengthened and synapses that contributed to unfavorable outcomes are weakened making it so future routing decisions are better biased toward actions that historically satisfy policies, SLO's, cost or power constraints.

The orchestrator 400 may further include a quantum-inspired embedder 408, which may also be referred to as a hybrid embedder, a quantum embedder, or simply an embedder 408. The embedder 408 may perform optimal task-resource matching and high-complexity system state prediction, and represent tasks as states inspired by quantum mechanics. The embedder 408 may be configured to produce embeddings for tasks and resources used for task-resource matching and system state prediction by the planner 404

By representing tasks as quantum-inspired mathematical states, the system can more accurately identify the best physical hardware (CPU, GPU, TPU, etc.) for a specific workload. The embedder 408 may create consistent unified vectors across multiple file types (text, image, audio, video), reducing search latency across diverse datasets.

In one embodiment, the embedder 408 extracts a feature vector for a task from raw task data received by the orchestrator 400 (e.g., complexity, memory requirements, deadline, cost constraints, compliance levels), applies dimensionality reduction (e.g., principal component analysis (PCA)) to create a lower-dimensional embedding while retaining a high portion of variance, and computes similarity (e.g., via an inner product) between task embeddings and resource embeddings. The orchestrator uses the task embedding, combined with the current system state map, and provides the planner 404 with the base task structure for initializing the planner's search tree. The embedder's similarity score may be used by the planner 404 to rank candidate resources and to resolve ties among candidate plans generated by the planner 404.

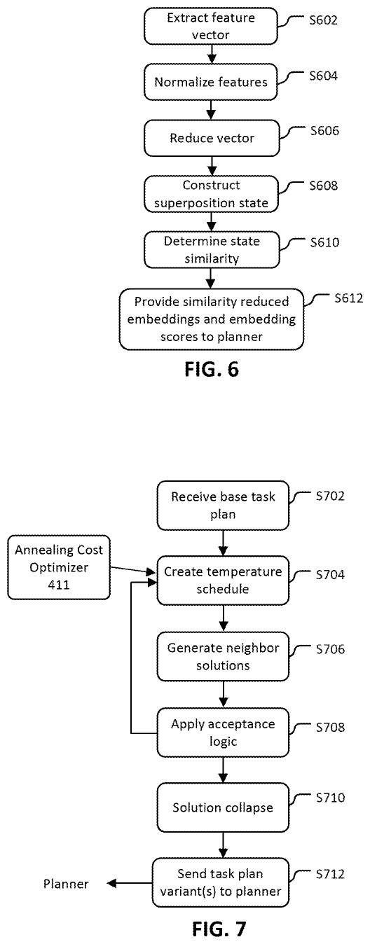

FIG. 6 illustrates an embodiment of an embedding process that may be performed by the embedder 408. At S602, a feature vector is input into or created by the embedder 408. The feature vector may be created by extracting a multi-dimensional vector from an incoming task. In an example, the vector is a five-dimensional (5D) vector with dimensions for complexity, memory requirements, deadline, cost constraints, and compliance levels. Other embodiments are possible.

The features may be normalized at S604, e.g., by subtracting the mean of all vectors and dividing by the standard deviation. The normalized vector is then reduced to a lower dimensionality at S606. Because processing high-dimensional data in real-time is computationally expensive, the system 100 may apply dimensional reduction such as PCA to reduce the 5D vector into a more manageable 2D embedded vector while retaining over 95% of the variance.

The core of the “quantum-inspired” approach is the creation of a superposition representation of the task state at S608. The task may be represented mathematically as a pure state (|ψ [symbol] ) at S608 where the normalized features serve as complex amplitude vectors. This representation allows the system 100 to treat a task as existing in a superposition of all possible resource states simultaneously during the evaluation phase, which is a phase in which the superposition task state is compared against candidate resource states to compute compatibility, and map it directly to the similarity computation and the ranking/selection output to determine similarity.

To determine the best fit, the embedder 408 performs a similarity computation at S610 using, for example, an inner product [symbol] ψ|φ [symbol] between the task embedding and various system resource embeddings. The embedder 408 may generate a similarity score between 0 and 1, ranking the top three resource embeddings with the highest compatibility to the task's specific constraints. System resource embeddings are the embedding vectors representing candidate execution resources that a task might run on. For each resource, normalized features are recoded such as: hardware type/capabilities (CPU/GPU/NPU, memory size/bandwidth, supported precision); current allocatable capacity such as utilization, queue depth, or reservations; observed performance such as tokens/sec, latency, error rates; or policy attributes such as data locality/compliance domain/tenant isolation. Those features are then mapped into an embedded vector in the embedder 408.

The scores, e.g., the top three scores for a task, may be provided to the planner 404 along with similarity reduced embeddings at S612. The planner 404 may use the scores as a tie-breaking mechanism for the planner 404 when multiple execution paths appear equally viable. In other embodiments, the scores may serve a different role in choosing an execution path. For example, the scores may be used as weights to assist the planner 404 or task router 406 with their respective functions.

Beyond matching, the embedder 408 may feed its dimensionality data into a quantum-inspired predictor. The quantum-inspired predictor may be a sub-module of the embedder 408 that analyzes the dimensions alongside the entire system state to forecast potential bottlenecks and cluster high-complexity tasks for better load optimization and may be used by the planner 404 for additional search tree expansions.

The orchestrator 400 may include a simulated annealing optimizer, which may also be referred to as a simulated annealer, an annealing cost optimizer, or simply an annealer 410, which is configured to refine the base task plan from the planner 404, into an improved task plan by exploring neighboring solutions and minimizing an energy objective.

In one embodiment, the energy objective is a weighted combination of latency, cost, and SLA violations. The annealer 410 ingests an initial base task plan (e.g., from planner 404), applies a temperature schedule with gradual cooling, generates neighbor solutions by swapping tasks among resources, applies an acceptance criterion (e.g., Metropolis-Hastings) to escape local minima early and converge later, and collapses to a final solution then transmitted to the planner 404 as a task plan variant used for further decision-tree exploration, simulation and eventual orchestrator 400 execution.

The primary function of the annealer 410 is to minimize “energy,” which may be defined as a weighted combination of latency, financial or energy cost, and SLA violations. The annealer 410 may ensure that the final routing for a task is not just functional but optimized against the current state of heterogeneous hardware (e.g., CPU, GPU, TPU, FPGA, and QPU-simulated lanes) of a compute environment.

The annealer 410 serves as a global optimization engine for system 100 and may be responsible for refining resource allocation and scheduling decisions. While the planner 404 identifies a strong initial path, the annealer 410 explores a complex energy landscape containing, for example, 1,000 or more local minima to settle on the most performant and cost-effective solution. Here, the energy landscape may be represented by a computed vector, wherein the vector represents points in the landscape that correspond to a particular assignment of tasks to resources, concurrency limits, ordering constraints, energy constraints and/or budget parameters.

In more detail, the energy landscape may refer to an objective function evaluated over a space of candidate allocations and schedules, wherein each point in the landscape corresponds to a particular assignment of tasks to resources, concurrency limits, ordering constraints, and/or budget parameters, and the energy is a scalar score representing predicted inefficiency or penalty for higher energy corresponds to worse latency, higher cost, or more violations.

Local minima may refer to a candidate allocation or schedule for which no small fluctuation (perturbation) in a defined parameter/neighborhood swapping a task to a different node, changing a concurrency limit, adjusting a budget, or reordering a dependent subtask that yields a lower energy, even though other regions of the search space may contain lower-energy solutions.

A most performant and cost-effective solution may correspond to a solution having the lowest energy score among evaluated candidates while satisfying feasibility and policy constraints, where energy may be computed from weighted terms for predicted latency, predicted cost, predicted energy, and penalties for violations.

The annealer 410 may be configured to refine an initial allocation or schedule by iteratively proposing candidate modifications and accepting or rejecting such candidates according to a temperature-controlled acceptance rule, thereby searching for improved solutions under one or more or SLO, cost, feasibility, and/or policy constraints.

FIG. 7 illustrates an embodiment of an annealing process that may be performed by an annealer 410. The annealer 410 may follow a multi-phase process to reach convergence, and may achieve a result in under 50 ms, for example.

The process initiates by receiving an input at S702. The input may be a resource allocation scheme, or base task plan which is a result of the planner 404, and the input may be received from the planner 404 or the quantum embedder 408, for example.

The annealer 410 initializes a temperature at S704. For example, the temperature may initialize at a starting value such as 100 (T0=100.0) which gradually decreases according to a cooling rate (α=0.95). An MLA associated with the annealer 410 may be trained on the actual heating and cooling performance of various chipsets as a function of throughput, to inform its behavior.

The annealer 410 generates neighbor solutions at S706. The neighbor solutions may be generated by swapping a task to a different resource and calculating the resulting change in energy (E′).

The annealer 410 may apply acceptance logic at S708. To avoid getting stuck in suboptimal local valleys, the annealer 410 may use the Metropolis-Hastings criterion. Early in the process (when “hot”), the annealer 410 may accept a worse solution to explore new possibilities; as it “cools,” annealer 410 becomes more selective, eventually settling on a global optimum. The annealer 410 may re-iterate steps S704 to S708 until a global optimum is realized.

The annealer 410 collapses a solution at S710. For example, multiple solution attempts may be run in parallel as a “wavefunction” of possibilities. At the point of execution, this wavefunction collapses into a single, best-known routing solution. In some embodiments, the annealer 410 may apply a Hybrid Quantum-Classical Annealer (HQCA) model to facilitate these activities. After the routing solution is collapsed at S710, the solution may be output from the annealer 410 as a task plan variant which may be transmitted to the planner 404 at S712. The planner 404 may consider and incorporate the task plan variant from the annealer 410 into a final task plan.

In some embodiments, the annealer 410 may operate in conjunction with an annealing cost optimizer 411. The annealing cost optimizer 411 may use a quantum-inspired sinusoidal cost function to ingest compute resource cost metrics and specifically solve for the lowest financial expenditure across a compute environment, e.g., a set of heterogeneous hardware resources.

The orchestrator 400 may further include a lane router 412. The lane router 412 may also be referred to as a multi-lane execution router or a lane picker, and may include circuit analysis functionality. The lane router 412 may analyze quantum-inspired circuits and automatically route them to the most efficient execution lanes in O(1) constant time.

In one embodiment for quantum-inspired circuits, the lane router 412 extracts circuit features, which may include, by way of example, one or more of: qubit count, circuit depth, Clifford gate ratio, treewidth estimate, Wigner negativity bound, and variational parameters. Based on these metrics, the lane router 412 selects an execution lane including: (i) state-vector, (ii) tensor network, (iii) stabilizer/QEC, (iv) variational/VQE, (v) neuromorphic lane where applicable, and/or (vi) a variance-reduction lane for high-negativity circuits.

The lane router 412 may operate by extracting a specific set of features from an incoming quantum-inspired circuit to determine which mathematical approach and hardware backend will yield the highest performance. A quantum-inspired circuit may refer to a classical data structure (e.g., a gate list, tensor network, or intermediate representation) that describes a computation using quantum-circuit primitives (qubits, gates, and connectivity) for purposes of classical evaluation, simulation, compilation, or routing, and does not require execution on quantum hardware. The mathematical approach may refer to a family of classical algorithms selected to evaluate or simulate the quantum-inspired circuit, including, by way of example, exact state simulation, stabilizer Clifford simulation, tensor-network contraction, quasi-probability and sampling-based estimation, and variational hybrid optimization workflows. These metrics may include, for example, one or more of:
1) a qubit count (n) which determines if a circuit is small enough for exact simulation or requires approximate methods;
2) a circuit depth (d) which Identifies deep circuits that may benefit from tensor network contraction;
3) a Clifford ratio (rcliff) which measures the fraction of Clifford gates to identify circuits suitable for polynomial-time stabilizer simulation;
4) a treewidth estimate (ω) which assesses the entanglement structure to determine if a Tensor Network approach is viable;
5) a Wigner negativity bound (ν) which detects high-noise or complex circuits that require advanced variance reduction; and
6) variational parameters (θ) which flags circuits designed for hybrid quantum-classical optimization loops.

In the above description, deep circuit may refer to circuits whose circuit depth such as sequential gate layers on the circuit's critical path exceeds one or more thresholds such that exact simulation becomes impractical and are better suited to methods that exploit structure for a tensor-network contraction or approximate/sampling methods. Fraction of Clifford gates, also called Clifford ratio, may refer to the proportion of gates in the circuit that are Clifford operations generated by common Clifford gates such as Hadamard, phase, and CNOT, relative to total gates, which is informative because circuits dominated by Clifford structure are often more efficiently classically simulated than general circuits. Entanglement structure may refer to the connectivity and interaction structure induced by multi-qubit gates and the resulting tensor-network graph, which can be thought of as a graph that measures features such as treewidth contraction complexity that correlate with the computational cost of tensor-network contraction. Hybrid quantum-classical optimization loops may refer to workflows in which a parameterized circuit is evaluated and/or simulated repeatedly to produce objective measurements, and a classical optimizer iteratively updates circuit parameters to improve cost function loops.

Based on the features above, the lane router 412 selects one of the following lanes for execution on hardware resources (e.g., CPU, GPU, TPU, FPGA, or NPU):
1. State-Vector Lane 504: Selected for small circuits (n≤28 qubits), provides exact amplitude simulation using a Go package.
2. Tensor Network Lane 506: Selected for large circuits (n>28) with low entanglement (treewidth ω<10), uses Matrix Product State (MPS) decomposition to achieve polynomial memory scaling.
3. Stabilizer/QEC Lane 508: Selected for Clifford-dominated circuits (rcliff>0.8), utilizes the Gottesman-Knill theorem for polynomial-time simulation and integrates real-time error correction decoders.
4. Variational/VQE Lane 510: Selected when variational parameters (θ) are present, manages hybrid optimization loops for molecular energy or combinatorial problems.
5. Neuromorphic Lane 406: This lane may be the neuromorphic task router 406, which may be selected for event-driven or sparse activation patterns. The task router 406 may select this lane within the orchestrator 400. The neuromorphic lane of task router 406 may use software-simulated spiking neural networks (LIF/STDP) to process tasks based on spike-timing, as described above.
6. QACC-VR Lane: 512 Selected for circuits with high negativity (ν>0.5), this lane may provide 40-60% variance reduction to make classical simulation of complex quantum algorithms practical.
These lanes are explained in more detail in other parts of the disclosure.

The orchestrator 400 may include a task dispatcher 414 configured to generate a dispatch plan as described above based on the combined outputs of the planner 404, task router 406, embedder 408, annealer 410, and lane router 412. In one embodiment, the dispatch plan is recorded as a versioned, auditable artifact.

The dispatcher 414 may select a queue (e.g., subject-based) for a task, track active tasks and resource loads across a cluster, and dynamically adjust allocations to route tasks away from constrained resources when overload is predicted or detected. Accordingly, the dispatcher 414 may act as an element of a load optimizer.

The dispatcher 414 may select the optimal NATS JetStream subject-based queue for each task and submit dispatch plans to streaming service 316. The dispatcher 414 may act as a load optimizing control-plane dispatching component that materializes dispatch plans into subject-based routing and enforces placement and backpressure decisions at the task/message layer.

In an embodiment, the dispatcher 414 is a dispatch actuator that takes a finalized task plan 418 (e.g., binding decisions from embedder/planner/router/annealer/lane-router) and selects a messaging route such as NATS JetStream subject/stream/consumer group. The dispatcher 414 then applies one or more of backpressure/re-route/re-plan triggers when conditions change.

The dispatcher 414 may be a control-plane dispatch component that materializes dispatch plans into subject-based routing and enforces placement and backpressure decisions at the task/message layer. Accordingly, dispatcher 414 is distinct from a conventional packet-level load balancer. While the dispatcher 414 may perform plan materialization and message-layer routing subject selection consistent with resource allocations and constraints, a different component (e.g., device manager 502) may determine and enforce allocatable capacity for reservations and admission control.

The dispatcher 414 may operate based on resource availability, e.g., allocatable capacity at decision time such as utilization, queue depth, reservations, health/error rate, rather than just existence of the resource.

Tasks may be executed by one or more execution lanes within the execution layer 500, an embodiment of which is illustrated in FIG. 3.

The execution layer 500 includes a device manager 502, which may also be referred to as a heterogeneous device manager. The device manager 502 may discover and register compute resources, monitor queue depths, bind tasks to chosen resources, and may scale agents based on operational feedback.

In some embodiments, the device manager may include and execute a HyperAdaptive Decomposition & Approximation Service (HDAS). In some embodiments, the device manager 502 handles the physical and virtual allocation of hardware, and HDAS focuses on mathematically optimizing the data and models to fit that hardware efficiently.

In particular, the device manager 502 may determine and enforce allocation of capacity across diverse system resources including processors (CPU's, GPUs, TPUs, FPGAs NPUs or QPUs), and memory spanning hardware environments, public and private cloud, or edge resources treating them as a single, fused resource plane comprising hardware resources.

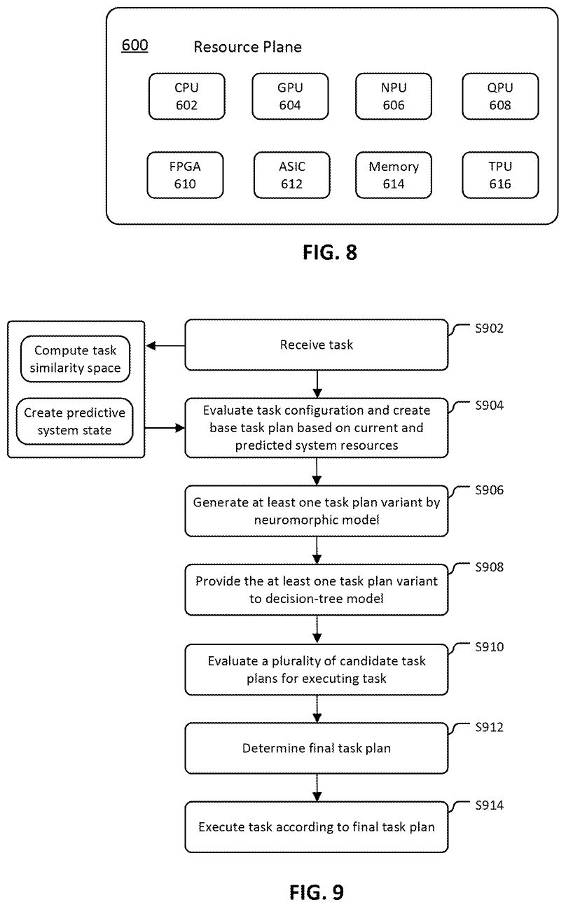

FIG. 8 illustrates an example of a resource plane 600 according to an embodiment. A resource plane 600 may include a set of heterogeneous resources which execute a compute task according to a resource plan as discussed above. Examples of hardware resources which may be present in a resource plane 600 include a CPU 602, a GPU 604, an NPU 606, a QPU 608, and FPGA 610, an ASIC 612, a memory 614, and a TPU 616. A system 100 may be scalable to operate on a resource plane 600 as small as a single computer with a CPU 602 and memory 614, or as large as a hyperscale data center with many thousands of diverse processors and memory types which change over time.

At startup, the device manager 502 automatically detects available compute resources (e.g., NVIDIA® GPUs via nvidia-smi, AMD® GPUs via rocm-smi, TPUs via cloud APIs, and FPGAs via XRT) and registers their specific capabilities and real-time queue depths. The device manager 502 continually analyzes the environment for new resources, or resources that should be pruned from the abstraction pool. The device manager 502 may bind a task to the specific physical hardware which executes the task. Device manager 502 may integrate with container orchestrators like Kubernetes, Knative, and KEDA to scale system resources up or down based on scaling policies, SLOs, and real-time feedback such as power usage, latency, node availability and queue depth. For example, a larger number of tasks and resources result in more neurons, so a number of agentic sub-routines of the orchestrator 400 may also automatically scale to process those additional tasks and resource routings.

The device manager 502 may execute HDAS to reduce compute and energy usage by optimizing model weights and data before execution. In such embodiments, device manager 502 accepts large-scale data (such as LLM weights) and outputs a compressed or pruned version that maintains high fidelity. HDAS may perform a multi-phase optimization flow including:
1. Factorization by applying wavelet transforms to identify localized patterns and l-Mul matrix factorization to preserve main variance while cutting unimportant dimensions;
2. Multi-Phase Distillation by iteratively distilling key features, pruning redundancies identified during the factorization steps;
3. Adaptive Quantization by applying quantization (e.g., 4-bit or 8-bit) to intermediate states, capturing maximum memory gains without losing critical information;
4. Verification in which a final “compressed artifact” is recombined and subjected to a fidelity check to ensure accuracy remains within acceptable thresholds; and
5. Large Language Model (LLM) Support in which the HDAS is specifically utilized to enable the use of LLMs on limited computational resources, significantly reducing their memory footprint.

The device manager 502 may provide an environmental monitor with metrics via Open Telemetry (OTEL) such as power consumption and latency for specific hardware. HDAS uses this information to decide how aggressively to prune or quantize a task; if the device manager 502 reports that a resource is energy-constrained or low-performing, HDAS may assign lower-computational-resource versions of the task to that device to maintain stability.

The execution layer 500 provides compute and memory resource allocation and processing for system workloads, where appropriate workloads are executed in specialized processing pipelines and processed results are combined. The execution layer 500 may process classical or quantum workloads, with quantum workloads being processed in specific execution lanes, to simulate quantum mechanics mathematically on classical computing hardware such as CPUs, GPUs, TPUs, FPGAs, and NPUs. For non-quantum workloads, the device manager 502 may communicate directly with the results combiner 514 (described below) to execute non-quantum tasks on hardware resources of the resource plane 600, bypassing the quantum execution lanes 504 to 512.

The lane router 412 may analyze incoming circuits and record its analysis to a dispatch plan that the orchestrator 400 will then route to the optimal lane in O(1) constant time. This decision may be based on specific circuit metrics, including qubit count, gate depth, the ratio of Clifford gates, treewidth (entanglement structure), and Wigner negativity.

The execution layer 500 may include a state vector lane 504 which may provide exact quantum amplitude simulation of quantum circuits on classical hardware (e.g., a CPU or GPU). This simulation is possible without engaging physical quantum processing units (QPUs). Here, exact quantum amplitude simulation may refer to a classical simulation method that computes the full complex amplitudes of a quantum circuit's state (i.e., the coefficients of each computational basis state) without approximation, typically by numerically applying gate operations to an explicit state representation.

The state vector lane 504 may operate by maintaining a full 2n complex state vector. The quantum state is represented mathematically as a pure state. Memory scaling is exponential, typically O(2n), requiring 16 bytes×2n when using complex 128 data types. The state vector lane 504 may be powered by a Go quantum simulation package, a pure-Go implementation that runs on standard CPU/GPU hardware. State vector lane 504 is the preferred lane for circuits for which exact state evolution is performed and are considered “small,” typically limited to n≤28 qubits. Complex 128 data types may refer to a numerical representation for complex numbers using 128 total bits, typically implemented as two 64-bit floating point values (one for the real part and one for the imaginary part), often corresponding to complex64/complex128 nomenclature where the underlying scalar precision is double-precision. Exact state evolution may refer to a simulation in which the quantum state is updated exactly according to the circuit's gate sequence within the numerical precision of the chosen floating-point type, without using approximation schemes such as truncation, sampling-only estimators, or reduced representations.

The tensor network lane 506 performs efficient simulation of quantum circuits on classical hardware by exploiting the structure of entanglement within the circuit. It provides polynomial-memory quantum-inspired simulation for circuits that exhibit low entanglement. This approach overcomes the exponential memory limits faced by the State-Vector Lane. The tensor network lane 506 may represent quantum states as networks of contracted tensors, such as the Matrix Product State (MPS) representation. Projected Entangled Pair States (PEPS) decomposition may also be supported.

The tensor network lane 506 may perform memory scaling in which the memory requirement scales polynomially, typically O(χ2n), where n is the number of qubits and χ is the bond dimension (a measure of entanglement). This contrasts with the O(2n) exponential scaling of the state vector lane 504. The tensor network lane 506 may be implemented for circuits that exceed the size limit of the state vector lane 504 (e.g., >28 qubits), particularly those ranging from 50 to 100 qubits, provided they have low treewidth (ω<10). The tensor network lane 506 is also suitable for deep circuits. The tensor network lane may be selected when qubit count is beyond state vector feasibility and the circuit has a structure as a low treewidth/limited entanglement that makes tensor contraction tractable.

The stabilizer/QEC lane, or stabilizer lane 508, is optimized for Clifford-dominated circuits. Stabilizer lane 508 may be automatically selected by the lane router 412 in O(1) constant time when a circuit analysis reveals that Clifford gates exceed 80% of the total gate composition. This lane serves as the system's high-efficiency engine for workloads where entanglement and complex non-Clifford rotations are minimal. By offloading these specific circuits to the stabilizer lane 508, the orchestrator 400 preserves more computationally expensive resources (like the QACC-VR or State-Vector lanes) for high-negativity tasks.

O(1) constant time may refer to a computational cost classification indicating that the runtime of an operation is asymptotically independent of input size qubit count or depth, typically because the operation is a fixed-cost classification/lookup reading precomputed circuit metrics or applying threshold rules, notwithstanding real-world constant factors.

Clifford gates may refer to a class of quantum gates that map Pauli operators to Pauli operators under conjugation and generate the Clifford group (common examples include Hadamard, phase/S, and CNOT), for which circuits composed solely of such gates admit efficient classical simulation via stabilizer methods such as Gottesman-Knill.

Total gate composition may refer to the overall gate inventory of a circuit, such as the total number of gates and their types/classes how many Clifford vs non-Clifford gates, optionally weighted by gate cost giving multi-qubit gates higher weight. High-negativity may refer to a circuit/state characteristic indicating large quasi-probability negativity under a chosen quasi-probability representation such as a discrete Wigner function.

Stabilizer lane 508 may leverage the Gottesman-Knill theorem, which enables the simulation of Clifford circuits on classical hardware in polynomial time (O(n2) per gate) rather than exponential time. Instead of a full state vector, quantum states may be represented as a stabilizer tableaux using 2n×(2n+1) binary matrices. Due to its mathematical efficiency, this lane can support simulations involving 1000+ logical qubits for pure Clifford workloads, far exceeding the 28-qubit limit of the State-Vector Lane.

Real-time QEC decoders may be integrated in stabilizer lane 508 for maintaining the integrity of quantum information. The stabilizer lane 508 may support high-performance decoders such as, for example, Union-Find, which is optimized for surface codes with a total decode latency of <2 μs; Minimum Weight Perfect Matching (MWPM), which utilizes the Blossom V algorithm for high-accuracy decoding with approximately 10 μs latency; Belief Propagation and Ordered Statistics Decoding (BP-OSD) which may be employed for LDPC codes with roughly 5 μs latency; and Neural Decoders which leverage trained networks for learned error models with ~1 μs latency.

To achieve real-time performance, the stabilizer lane 508 may be coupled with specialized hardware such as one or more of an FPGA which may use Xilinx XRT to implement pipelined Union-Find decoders, facilitating sub-microsecond error correction; NPUs which may be used to accelerate neural-based QEC decoders, and CPU/GPU backends which may perform Standard simulation tasks using AVX-512 on CPUs or CUDA on GPUs for optimized binary matrix operations.

The variational lane 510 is designed for hybrid quantum-classical optimization problems. It provides a quantum-inspired hybrid optimization engine specifically tailored for variational quantum algorithms (VQAs) such as the Variational Quantum Eigensolver (VQE) and Quantum Approximate Optimization Algorithm (QAOA).

The variational lane 510 may find the ground state energy of molecular Hamiltonians or solve combinatorial optimization problems. The variational lane 510 may combine quantum-inspired circuit execution (simulation of the parameterized circuit or ansatz) with classical optimization loops. The quantum-inspired circuits can be executed on classical hardware, typically utilizing the capabilities of the state vector lane 504 or the tensor network lane 506 for the actual circuit simulation. The variational lane 510 may handle tasks specifying quantum-inspired circuit operations (ansätze) and classical optimization details. Ansätze is a parameterized circuit template defining a family of circuits having a predetermined structure and one or more tunable parameters, such that different parameter settings instantiate different candidate solutions evaluated during a variational optimization process.

The primary function of the QACC-VR lane 512 is to enable efficient quantum algorithm simulation on regular classical hardware (CPU/GPU/NPU) by dramatically reducing the statistical noise, or variance, associated with expectation value estimation. Variational quantum algorithms (VQAs) and Monte Carlo sampling methods suffer from high shot noise variance, requiring vast numbers of samples (shots) for precise results. The QACC-VR solution may reduce this variance by 40-60%.

Computations of QACC-VR lane 512 may be performed as classical simulations using the Go simulation package on standard CPU/GPU hardware. The reduction in samples translates to a 20-40× speedup for typical 50-qubit circuits compared to naive Monte Carlo methods. QACC-VR lane 512 may be the selected lane for circuits exhibiting high Wigner negativity (ν>0.5), indicating high noise or complexity suitable for variance reduction techniques. QACC-VR lane 512 may be integral to the flow of VQE lane 510.

The results combiner 514 may be a coordination and consolidation component within the execution layer 500 configured to finalize outputs produced by distributed workers executing sharded subtasks of a larger workload, and to ensure that the system remains highly efficient by minimizing redundant communications.

In more detail, the results combiner 514 may be a coordination and consolidation component within the execution layer 500 configured to finalize outputs produced by distributed workers executing sharded subtasks of a larger workload. The results combiner 514 may be implemented as an agentic sub-routine process executed by one or more processors of system 100 that maintains a task-level view of subtask completion, dependency ordering, and result integrity. The results combiner 514 may receive partial outputs from a plurality of workers, validate the partial outputs by checking schema, hashes, version identifiers, or verifier signals, perform de-duplication and conflict resolution when partial results overlap, and merge the partial outputs into a unified result artifact suitable for return to an upstream service or client. To minimize redundant communications, the results combiner 514 may employ one or more communication-reduction strategies including batching acknowledgments, aggregating intermediate updates into periodic summaries, suppressing duplicate transfers by using content addressing or idempotency keys, and/or retrieving only missing portions of partial results based on completion and integrity metadata, thereby reducing repeated polling and unnecessary network round-trips while preserving correctness and auditability.

The results combiner 514 may consolidate distributed outputs. For example, when an advanced parallelizer, which is a management service for a high concurrency architecture, shards a massive task, such as a large-scale graph operation or machine learning training job, into subtasks across multiple cluster nodes or ephemeral workers, the results combiner 514 is the component that gathers these partial results. The results combiner 514 monitors the progress of workers and collects completed artifacts once they have been successfully processed.

When the advanced parallelizer shards a task into subtasks, the results combiner 514 gathers these partial results. The logic of this sharding and subsequent merging is recorded in audit sub-ledgers (e.g., customer audit sub-ledger (CASL) and platform audit sub-ledger (PASL)) to maintain an immutable evidence chain.

The system 100 can handle multimodal data, including text, audio, video, and images. The results combiner 514 may identify these diverse data types and unify them into a single, consistent structure that can be easily consumed by the requesting application or the next stage of the processing pipeline.

The results combiner 514 may reduce network round-trips. Instead of requiring the client or an upstream service to make multiple calls to fetch pieces of a distributed task, the combiner merges partial results into a single coherent deliverable. The results combiner 514 may regularly calculate summaries or aggregates to reduce the total amount of data that is transmitted.

The results combiner 514 performs conflict resolution and validation. In high-concurrency environments, partial results may occasionally overlap or conflict. The results combiner 514 is tasked with identifying these inconsistencies and resolving them according to system rules to ensure the final output is accurate and unified. Once consolidated, the data is validated and recorded in the system's ledger or persistent storage for future reference and auditability.

The results combiner 514 may identify inconsistencies or overlaps in partial results and resolve them based on system rules. Once finalized, the results may be validated and recorded in the system's persistent storage or ledger for future auditability.

While the combiner 514 handles data, a separate component, e.g., a data lineage service, may manage associated metadata.

The results combiner 514 may gather transformation and usage info from a caching framework and constructs a lineage chain with versioning. The results combiner 514 may ensure compliance by maintaining historical relationships for field-level data, allowing the system to prove the origin and transformation history of any specific piece of data.

Another unique feature of this system is the use of CoT reasoning tokens. A Platform CoT & Reflection Service creates these tokens based on actions occurring in the platform (such as why a particular resource was utilized or which quantization strategy was chosen). These tokens are attached to results as “reflection tokens,” providing an “explainable log” that describes the “why” behind the output for regulatory audits.

Embodiments of the present disclosure provide numerous technological improvements, and in particular, substantial improvements to performing compute tasks using heterogeneous hardware resources. In one embodiment, an agentic orchestration pipeline produces a dispatch plan using a combination of MLAs trained on and executing various aspects of the compute process. An MLA may be embodied on hardware including at least a memory 054 as a trained model which may be executed by a processor 052, for example, to perform one or more processes of the present disclosure. The orchestrator 400 may operate as a plurality of agentic sub-routines that collectively transform a validated task envelope into a dispatch plan.

In an embodiment, the orchestrator does not merely perform scheduling, but is an integrated control-plane pipeline that: (i) computes task similarity and creates embeddings; (ii) uses those embeddings to decompose tasks and forecast feasibility via MCTS; (iii) learns routing utility via neuromorphic online STDP learning (in which online learning is learning for which internal parameters are updated continuously during operation using live data from a current execution stream without retraining or replaying a stored dataset); (iv) refines global allocation via annealing optimizations, and (v) materializes the plan into a versioned artifact used for binding execution. The orchestrator 400 improves adaptability under changing workloads and resource conditions while maintaining enforceable SLO, cost, and feasibility constraints. The orchestrator 400 provides numerous benefits including reducing task overhead by about 20% to 70% or more, improving end-to-end tail latency by about 5 to 35% or more, and reducing energy cost of compute operations by about 5 to 35% or more, for example. Of course, these values are merely exemplary, and may vary based on the type of task, hardware resources, learning state of aspects of the system, etc. The inventors have found that embodiments of the present disclosure result in substantial improvements in efficiency when executing compute tasks according to embodiments of the present disclosure.

FIG. 9 illustrates an embodiment of a method for executing a compute task using heterogeneous hardware resources of a compute environment. The method of FIG. 9 may be performed by a system 100 according to the present disclosure.

A task is received by the system 100 at S902. For example, a task may be received at an API gateway/edge entry 252 of an ingress layer 250 as discussed above. The task may include data to be processed (executed) by hardware resources of a resource plane 600 of the system 100. In addition, the task may include a configuration, e.g., parameters for executing the task. In particular, the configuration may include one or more SLO (e.g., latency goal) for executing the task, task type, priority, processor requirements, memory requirements, timeouts, and metadata including SLO, cost constraints, processing location, and compliance requirements as discussed above. The task configuration may be recorded as metadata associated with the task.

In some embodiments, receiving the task at S902 may include receiving, via an ingress interface, a compute task encoded as a task envelope that specifies execution constraints including one or more of a latency objective, a cost objective, a feasibility constraint, and a policy constraint. A feasibility constraint may evaluate the latency and cost objectives, and the policy constraints against whether or not the proposed task plan will satisfy those objectives and policy constraints. A policy constraint may be, for example, a GDPR policy that requires specific regional handling of data, a HIPAA policy that requires specific encryption, or a policy that constrains task execution by limiting the specific actions a task is permitted to trigger.

The task configuration is evaluated and a base task plan is created based on current system resources at S904. The task configuration evaluation may include task structure analysis and similarity reduction performed before creating the base task plan. One or more elements of the task configuration evaluation and base task plan creation may be performed by the planner 404, which may include a trained decision-tree model. In an example, the planner 404 may compare constraints of the task configuration to current hardware resources of the system 100 and create a base task plan for executing the task using the current hardware resources. In an example, if the configuration includes hardware constraints and an SLO, the planner 404 creates a base task plan with hardware resources that can satisfy the SLO. The planner 404 may leverage model training from actual and/or simulated task execution to evaluate appropriate hardware for satisfying the SLO.

In addition, the decision tree model may capture a resource-state snapshot that encodes allocatable capacity and health (e.g., status or condition such as a current thermal state or operating frequency) for eligible hardware resources including one or more of compute throughput, memory availability, queue depth, and network or storage bandwidth. A predictive system state may be incorporated into an initial struct the decision tree model uses to explore potential task solutions (e.g., the task envelope).

A base task plan may be generated as a canonical, executable plan for a task, and one or more alternative plans may be represented as derived variants that reference the base plan and store a delta specifying step-level edits, including additions, deletions, reordering, substitutions, or parameter changes.

A trained neuromorphic model, e.g., a task router 406, generates at least one task plan variant at S906. The neuromorphic model may generate at least one task plan variant for executing the compute task on a respective set of hardware resources. S906 may include generating, by a neuromorphic task router, a task plan variant that differs from the base task plan by at least one of device types, deviceID, compute pools, geographic locations, execution strategy, sequence or lane selection. The geographic location may be a physical location of hardware components, and may have implications for task execution based on associated regulations, as well as infrastructure and other aspects of the geographic location. The neuromorphic model may compute routing scores from live task signals and live telemetry using spiking-neuron state comprising leaky-integrate-and-fire accumulation and update adaptive synaptic weights using spike-timing-dependent plasticity gated by observed execution outcomes.

The neuromorphic model may explore multiple resource/routing configurations. For each one, a LIF network runs and may use a winner-take-all basis to select the best binding within that configuration, and output the best binding as a task plan variant. The neuromorphic model may generate a routing score that quantifies how confident the model is in each proposed variant. The routing score may correspond to a LIF output magnitude, for example.

The neuromorphic model may be continuously trained on task execution data associated with the heterogeneous hardware resources of the compute environment. The task execution data may include metrics associated with task execution, such as energy, cost, and latency. Accordingly, the neuromorphic model may be trained using training data including task data, hardware resources used to execute tasks, and metrics associated with task execution. The task plan variant may include hardware resources and parameters (e.g., voltage, memory allocation, frequency, etc.) for executing a task, and the hardware resources and parameters may be associated with different elements of a task, or sub-tasks, for total task execution. For example, if a task has multiple data components, the task plan variants may include a task decomposition structure with hardware resources and parameters for each discretely decomposed component.

In some embodiments, the neuromorphic model generates the task plan variants at S906 using only system resources that have been successfully used for similar tasks in the past as represented by neurons and simulated voltage thresholds between task and resource types as learned. In contrast, the decision-tree model may create the base task plan at S904 from the task embedding received from the embedder 408, combined with the state of all currently available system resources, regardless of whether those resources have been used to execute a similar task in the past. A similar task may be a task with similar task characteristics, e.g., a similar SLO, task type, task size, etc., and the similarity may be a configurable value such as 20%, such that two similar tasks have SLOs within 20% of one another. Of course, 20% is merely an example, and other similarity thresholds are possible. The at least one task plan variant may be a “first to spike” or a “best fit for the task” plan generated by the neuromorphic model.

The neuromorphic model provides the at least one task plan variant to the decision-tree model at S908. The decision-tree model may then select a task plan variant derived from its own node exploration; or where the neuromorphic model provides a better alternative, e.g., an alternative that better satisfies SLOs, reduces energy consumption, or executes more quickly, the decision-tree model may select that alternative and incorporate the variant. Accordingly, the decision-tree model may compare task plan actions generated by the decision-tree model to task plan variants generated by the neuromorphic model to determine which task plan elements to incorporate into a final task plan. The decision-tree model may also use the neuromorphic model task plan variants and associated routing scores to inform tie-breaks between multiple potential plans in its own decision tree nodes.

In some embodiments, the neuromorphic model may be coupled to the decision tree model such that, at each step and at predefined checkpoints, the neuromorphic model ingests real-time task and system signals (e.g., objective state, intermediate outputs, tool and resource availability, latency/error telemetry, and policy/compliance constraints) and produces routing scores using spiking-neuron dynamics (e.g., leaky integrate-and-fire state) with adaptive synaptic weighting updated online (e.g., STDP-like reinforcement based on observed outcomes).

The decision-tree based model evaluates a plurality of candidate task plans for executing the task at S910. For example, the decision-tree based model may perform a five -phase routing process as described above with respect to FIG. 4 to evaluate candidate task plans represented by nodes in an MCTS or other search tree. In some embodiments, the decision-tree based model may compare elements of candidate task plans generated by the decision-tree based model to one or more alternative task plan variants generated by the neuromorphic router as described above to evaluate the plurality of candidate task plans.

In some embodiments, S910 may include evaluating, by the decision-tree based model, the base task plan together with the task plan variants by executing a Monte Carlo tree search (or other tree search) over plan checkpoints as decision nodes and plan continuations or plan variants as actions using an exploration exploitation score that includes an upper confidence bound term and a rollout utility that depends on predicted latency, predicted cost, predicted error risk, and predicted policy compliance. The decision tree model may evaluate the base plan and its option-plan branches by treating checkpoints as decision nodes and plan variants represented in the expanded child nodes as actions, performing simulated rollouts over alternative variants, computing an expected-utility reward (e.g., quality, latency, cost, risk, and compliance), and applying an exploration/exploitation policy (e.g., UCB1) to select an expanded plan variant for execution or refinement.

A final task plan is determined at S912. The final task plan may include one or more of hardware resources, routing paths for routing data of the task, hardware parameters such as voltage and frequency, architecture type, and temperature that are used by the system 100 to execute the task, and the hardware resources and parameters may be associated with different elements of a task for total task execution. The final task plan may be determined by the decision-tree model, and the decision-tree model may use inputs from the embedder 408, depending on task complexity, and annealer 410, to help determine the final task plan.

The task is executed at S914 using hardware resources of the resource plane 600. The task may be executed based on the final task plan determined at S910.

Task execution may be performed dynamically with respect to the final task plan. For example, in some embodiments, the orchestrator 400 combines selection outputs from the decision tree model and the neuromorphic routing scores to select, promote, or switch between the base plan and one or more plan variants at runtime, including re-binding execution of steps to different sub-agents, tools, lanes, or hardware resources and adjusting or halting task execution under policy, resource, and outcome-gated control, while maintaining immutable plan lineage and auditability. More generally, the orchestrator 400 may use the routing scores from the neuromorphic model to select, promote, or switch between the base plan and plan variants including re-binding task execution to different sub-agents/tools/resources, or reordering task processing sequences under policy, resource, and outcome-based gating while preserving plan lineage. The neuromorphic model may, for example, continuously receive task performance, task policy and task validation status. If a task constraint change results in a mid-flight task being invalidated, the orchestrator may direct the planner to re-plan with the new cost-constraint in consideration.

In some embodiments, dynamic task execution at S914 may include measuring execution latency while executing the compute task, and re-assigning at least one remaining sub-task of the compute task to different hardware resources from the hardware resources associated with the task plan based on the measured execution latency. Reassigning the at least one remaining sub-task may be based on real-time system state or changes in system constraints such as latency, cost, hardware availability, and policy changes, and subsequent replanning of the mid-flight task execution generated by the neuromorphic model.

In some embodiments, the plan contents may serve as an immutable artifact as to task-specific execution predictions and configuration, wherein following task execution the task execution predictions and configuration are evaluated against task execution performance, and evaluated differences continuously retrain the neuromorphic model.

The system may perform continuous training and inference by streaming data and model outputs end-to-end, dynamically selecting and interleaving multiple datasets and learning techniques while enforcing real-time policy guardrails and feedback so that models are updated incrementally without intermediate storage or batch post-processing.

In some embodiments, training and inference flows run over concurrent gRPC streaming APIs (not generate-then-chunk). For example, the orchestrator 400 may drive models through staged, concurrent learning phases (e.g., CoT (Chain of Thought)→SFT (Supervised Fine Tuning)→DPO (Direct Preference Optimization)→GRPO (Group Relative Policy Optimization)/RLVR (Reinforcement Learning with Verifiable Rewards)) by selecting the active streaming datasets applying per-dataset method overrides as appropriate.

For model training, data may be ingested as streams, and not written to disk, either by a Go-side paginated fetchBatch() against a datasets-server API that continuously feeds a buffered channel, or by a worker that consumes load_dataset( . . . , streaming=True) and streams normalized examples directly into the same gRPC ingress stream. A multi-dataset run may interleave weighted dataset streams into a single unified training stream so the trainer sees one consistent sequence while preserving target mixture ratios. The training loop may concurrently drain this stream, assembles batches, execute the phase-specific step function (e.g., SynthiaStepFunc for CoT/GRPO), update optimizer state and metrics (loss/KL plus any replay/advantage signals), and enforce ComprehensiveSafeguard checks before and after each step (loss spike detection, gradient-norm bounds, regression caps) to prevent divergence and trigger backoff/rollback policies. Because the APIs are fully streaming, progress and outputs (telemetry, checkpoints/artifacts metadata, and optionally partial model responses) are emitted as gRPC streams in real time, and true token-level response streaming is achieved by the unified model's stream method rather than any buffered post-processing.

In an embodiment, within a neuromorphic model (e.g., task router 406), tasks are encoded into spiking representations, routing decisions arise from LIF dynamics and a winner-take-all selection, and synaptic relationships between tasks and resources are updated using STDP based on observed latency and success/failure outcomes. In embodiments of the present disclosure, neurons may not represent individual threads, processes, or packets. Instead, embodiments represent higher-level task-resource relationships rather than low-level scheduling primitives. These features result in sub-millisecond routing decisions that improve over time without static routing tables, yielding faster convergence to high-utility routing under drift in workload and resource availability.

Some embodiments include constant-time lane routing to specialized execution lanes using extracted circuit/task metrics. In an embodiment, a lane router 412 extracts circuit or task metrics and selects one of a plurality of execution lanes in constant time, where lanes correspond to different compute strategies and hardware backends. For example, the lane router 412 may select a stabilizer/QEC lane for Clifford-dominated circuits, or a variance-reduction lane for high Wigner negativity. Immediate selection of an appropriate execution strategy avoids expensive search operations and provides stable throughput and reduced tail latency for mixed workloads.

In some embodiments, a heterogeneous device manager binds dispatch plans to a unified resource plane. In an embodiment, a device manager 502 discovers heterogeneous devices (CPUs, GPUs, TPUs, FPGAs, NPUs), registers capabilities and queue depths, treats the fleet as a fused resource plane, and binds tasks to physical devices in accordance with a dispatch plan. Embodiments include integration with container orchestration for scaling (e.g., Kubernetes/Knative/KEDA). Accordingly, embodiments may provide a portable abstraction layer that enables dispatch plans to allocate heterogeneous compute while responding to dynamic availability and performance signals.

In one embodiment, an execution layer comprises multiple lanes and a results combiner that merges partial results from distributed workers into a unified output, reducing round-trips and resolving conflicts according to system rules. A multi-lane execution layer may result in reduced network overhead for distributed execution and consistent final outputs for multimodal workloads.

Embodiments of the present disclosure may be performed by a computer system including one or more processor 052 and one or more memories 054. For example, embodiments may be performed by a computer system comprising one or more memories and one or more processors coupled with the one or more memories and individually or collectively configured to cause the computer system to perform aspects of the processes described herein.

Aspects of the present disclosure have been described in conjunction with the specific embodiments thereof that are proposed as examples. Numerous alternatives, modifications, and variations to the embodiments as set forth herein may be made without departing from the scope of the claims set forth below. Accordingly, embodiments as set forth herein are intended to be illustrative and not limiting.

1. A method for executing a compute task using heterogeneous hardware resources of a compute environment, the method comprising:
receiving, via an ingress interface, a compute task;
constructing, by a trained decision tree machine learning model, a base task plan that associates the compute task with hardware resources of the compute environment;
generating, by a neuromorphic model, one or more task plan variants and a routing score for each task plan variant based on continuously learned routing performance encoded through spike-timing-dependent plasticity (STDP);
evaluating the base task plan together with the one or more task plan variant by executing a tree search based on one or more of predicted latency, predicted cost, predicted error risk, and predicted policy compliance of executing the compute task;
selecting a task plan based on a result of the evaluation and the one or more routing scores; and
executing the compute task by dispatching steps of the compute task to hardware resources of the compute environment according to the task plan.

2. The method of claim 1, further comprising:
persisting the task plan as a versioned plan artifact that references an earlier plan version corresponding to the base task plan; and
storing a delta record encoding step-level modifications relative to the earlier plan version.

3. The method of claim 2, further comprising:
storing the versioned plan artifact as a record of predicted execution characteristics and resource bindings.

4. The method of claim 2, further comprising:
after executing the compute task, comparing measured execution outcomes to predicted execution characteristics recorded in the versioned plan artifact and updating at least the adaptive synaptic weights of the neuromorphic model based on the comparison.

5. The method of claim 1, wherein the one or more task plan variant differs from the base task plan by at least one of sub-task sequencing, resource type, geographic location, energy consumption or policy constraint.

6. The method of claim 1, wherein the neuromorphic model generates the one or more routing scores from learned past task execution outcomes and real-time telemetry of hardware resources that function as simulated input currents to the neuromorphic model weighed against the elements of the compute task represented as simulated task neurons using a spiking-neuron state comprising leaky-integrate-and-fire accumulation, and updates adaptive synaptic weights using spike-timing-dependent plasticity based on further observed task execution outcomes.

7. The method of claim 1 wherein at least a portion of child nodes of the decision-tree model represent different potential task sharding strategies.

8. The method of claim 7, wherein at least a portion of child nodes of the decision-tree model represent currently available hardware resource pools.

9. The method of claim 1, wherein selecting the task plan includes choosing an task plan variant associated with a child of a root with a maximum number of node visits, or a second task plan variant associated with a maximum cumulative reward divided by a number of times that a node was visited, wherein the first and second task plan variants represent at least respective sets of hardware resources to which the compute task may be routed for task execution.

10. The method of claim 1, wherein, to select the final plan, the decision-tree model performs a four-phase routing decision process including a node selection phase, an expansion phase, a simulation phase, and a backpropagation phase.

11. The method of claim 10, wherein the simulation phase includes estimating execution time and resource utilization based on a heuristic of task complexity divided by resource capacity.

12. The method of claim 10, wherein the backpropagation phase includes backpropagating rewards from simulations of the simulation phase to update the statistics of parent nodes.

13. The method of claim 10, wherein the expansion phase includes generating child nodes representing resource types and resource eligibility based on allocatable capacity.

14. The method of claim 1, wherein the neuromorphic model includes a plurality of task neurons mapped to task characteristics and a plurality of hardware resource neurons mapped to hardware resources.

15. The method of claim 14, wherein the task characteristics include at least one of priority, size, resource availability, and historical latency.

16. The method of claim 14, wherein the hardware resource neurons are mapped to one or more of a processor type, a number of cores, a cache size, a frequency, a memory size, and a memory type.

17. The method of claim 1, further comprising:
measuring execution latency while executing the compute task; and
re-assigning at least one remaining sub-task of the compute task to different hardware resources from the hardware resources associated with the task plan based on the measured execution latency.

18. The method of claim 17, wherein reassigning the at least one remaining sub-task is based on real-time system state or changes in system constraints and subsequent replanning of the mid-flight task execution generated by the neuromorphic model.

19. A computer system comprising:
one or more memories; and
one or more processors coupled with the one or more memories and individually or collectively configured to:
receive, via an ingress interface, a compute task;
construct, by a trained decision tree machine learning model, a base task plan that associates the compute task with hardware resources of the compute environment;
generate, by a neuromorphic model, one or more task plan variants and a routing score for each task plan variant based on continuously learned routing performance encoded through spike-timing-dependent plasticity (STDP);
evaluate the base task plan together with the one or more task plan variant by executing a tree search based on one or more of predicted latency, predicted cost, predicted error risk, and predicted policy compliance of executing the compute task;
select a task plan based on a result of the evaluation and the one or more routing scores; and
dispatch steps of the compute task to hardware resources of the compute environment according to the task plan.

20. The computer system of claim 19, wherein the neuromorphic model includes a plurality of task neurons mapped to task characteristics and a plurality of hardware resource neurons mapped to hardware resources.

21. The computer system of claim 19, wherein the one or more processors are further individually or collectively configured to:
measure execution latency while executing the compute task; and
re-assign at least one remaining sub-task of the compute task to different hardware resources from the hardware resources associated with the task plan based on the measured execution latency.

22. The computer system of claim 21, wherein reassigning the at least one remaining sub-task is based on real-time system state or changes in system constraints and subsequent replanning of the mid-flight task execution generated by the neuromorphic model.
